(19) United States
(12) Patent Application Publication
(10) Pub. No.: US 2022/0225338 A1
(43) Pub. Date: Jul. 14, 2022

(54) METHOD AND APPARATUS FOR CONFIGURING AND DETERMINING DEFAULT BEAMS IN A WIRELESS COMMUNICATION SYSTEM

(71) Applicant: Samsung Electronics Co., Ltd., Suwon-si (KR)

(72) Inventors: Dalin Zhu, Richardson, TX (US); Eko Onggosanusi, Coppell, TX (US); Emad N. Farag, Flanders, NJ (US); Md. Saifur Rahman, Plano, TX (US)

(21) Appl. No.: 17/575,495

(22) Filed: Jan. 13, 2022

Related U.S. Application Data
(60) Provisional application No. 63/137,477, filed on Jan. 14, 2021.

(51) Int. Cl. H04W 72/10; H04W 72/04; H04W 72/02

(52) U.S. Cl. CPC H04W 72/10; H04W 72/046; H04W 72/02; H04W 72/042; H04W 72/0446

(57) ABSTRACT

Apparatuses and methods for configuration and determination of default beams in a wireless communication system. A method for operating a user equipment (UE) includes receiving a first physical downlink control channel (PDCCH) including a first downlink control information (DCI) format indicating one or more first unified transmission configuration indication (TCI) states, receiving a second PDCCH including a second DCI format indicating one or more second unified TCI states, and receiving information on a beam application time. The method further includes determining a quasi-co-location (QCL) assumption for reception of a physical layer shared channel (PDSCH) based on one of the one or more first and second unified TCI states and the beam application time and receiving the PDSCH according to the QCL assumption. Receptions of the first and second PDCCHs are in control resource sets (CORESETs) configured with same or different values of a coresetPoollndex.

### CROSS-REFERENCE TO RELATED APPLICATIONS AND CLAIM OF PRIORITY

The present application claims priority to U.S. Provisional Patent Application No. 63/137,477, filed on Jan. 14, 2021. The content of the above-identified patent document is incorporated herein by reference.

### TECHNICAL FIELD

The present disclosure relates generally to wireless communication systems and, more specifically, the present disclosure relates to configuration and determination of default beams in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to configuration and determination of default beams in a wireless communication system.

In one embodiment, a user equipment (UE) is provided. The UE includes a transceiver configured to receive: a first physical downlink control channel (PDCCH) including a first downlink control information (DCI) format indicating one or more first unified transmission configuration indication (TCI) states; a second PDCCH including a second DCI format indicating one or more second unified TCI states; and information on a beam application time. The UE further includes a processor operably coupled to the transceiver. The processor is configured to determine a quasi-co-location (QCL) assumption for reception of a physical layer shared channel (PDSCH) based on one of the one or more first and second unified TCI states and the beam application time. The transceiver is configured to receive the PDSCH according to the QCL assumption. Receptions of the first and second PDCCHs are in control resource sets (CORESETs) configured with same or different values of a coresetPoollndex.

In another embodiment, a base station (BS) is provided. The BS includes a transceiver configured to transmit: a first PDCCH including a first DCI format indicating one or more first unified TCI states; information on a beam application time; and a PDSCH for reception according to a QCL assumption that is based on (i) the beam application time and (ii) one of the one or more first unified TCI states or one or more second unified TCI states indicated in a second DCI format included in a second PDCCH. The first and second PDCCHs are in CORESETs configured with same or different values of a coresetPoollndex.

In yet another embodiment, a method for operating a UE is provided. The method includes receiving a first PDCCH including a first DCI format indicating one or more first unified TCI states, receiving a second PDCCH including a second DCI format indicating one or more second unified TCI states, and receiving information on a beam application time. The method further includes determining a QCL assumption for reception of a PDSCH based on one of the one or more first and second unified TCI states and the beam application time and receiving the PDSCH according to the QCL assumption. Receptions of the first and second PDCCHs are in CORESETs configured with same or different values of a coresetPoollndex.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIG. 6A illustrate an example of wireless system beam according to embodiments of the present disclosure;

FIG. 6B illustrate an example of multi-beam operation according to embodiments of the present disclosure;

FIG. 7 illustrate an example of antenna structure according to embodiments of the present disclosure;

FIG. 8 illustrates an example of multi-TRP system according to embodiments of the present disclosure;

FIG. 9 illustrates an example of unified TCI state indication according to embodiments of the present disclosure;

FIG. 10 illustrates an example of unified TCI state indication in a multi-DCI based multi-TRP system according to embodiments of the present disclosure;

FIG. 11 illustrates another example of unified TCI state indication in a multi-DCI based multi-TRP system according to embodiments of the present disclosure;

FIG. 12 illustrates yet another example of unified TCI state indication in a multi-DCI based multi-TRP system according to embodiments of the present disclosure;

FIG. 13 illustrates yet another example of unified TCI state indication in a multi-DCI based multi-TRP system according to embodiments of the present disclosure;

FIG. 14 illustrates yet another example of unified TCI state indication in a mult-DCI based multi-TRP system according to embodiments of the present disclosure;

FIG. 15 illustrates yet another example of unified TCI state indication in a multi-DCI based multi-TRP system according to embodiments of the present disclosure;

FIG. 16 illustrates an example of a signaling flow between a UE and a gNB according to embodiments of the present disclosure;

FIG. 17 illustrates an example of a signaling flow for configuring and determining a default TCI state according to embodiments of the present disclosure;

FIG. 18 illustrates an example of a signaling flow between a UE and a gNB according to embodiments of the present disclosure;

FIG. 19 illustrates an example of priority rule for configuring and determining default TCI state according to embodiments of the present disclosure;

FIG. 20 illustrates another example of priority rule for configuring and determining default TCI state according to embodiments of the present disclosure;

FIG. 21 illustrates a flowchart of a UE method for receiving and decoding PDSCH according to embodiments of the present disclosure;

FIG. 22 illustrates another flowchart of a UE method for receiving and decoding PDSCH according to embodiments of the present disclosure;

FIG. 23 illustrates yet another flowchart of a UE method for receiving and decoding PDSCH according to embodiments of the present disclosure;

FIG. 24 illustrates an example of unified TCI state indication in a single-DCI based multi-TRP system according to embodiments of the present disclosure;

FIG. 25 illustrates another example of unified TCI state indication in a single-DCI based multi-TRP system according to embodiments of the present disclosure;

FIG. 26 illustrates yet another example of unified TCI state indication in a single-DCI based multi-TRP system according to embodiments of the present disclosure;

FIG. 27 illustrates an example of configuring and determining default TCI states according to embodiments of the present disclosure;

FIG. 28 illustrates another example of configuring and determining default TCI states according to embodiments of the present disclosure;

FIG. 29 illustrates an example of priority rule for configuring and determining default TCI state according to embodiments of the present disclosure; and

FIG. 30 illustrates a flowchart of a method for configuring and determining a default beam according to embodiments of the present disclosure.

### DETAILED DESCRIPTION

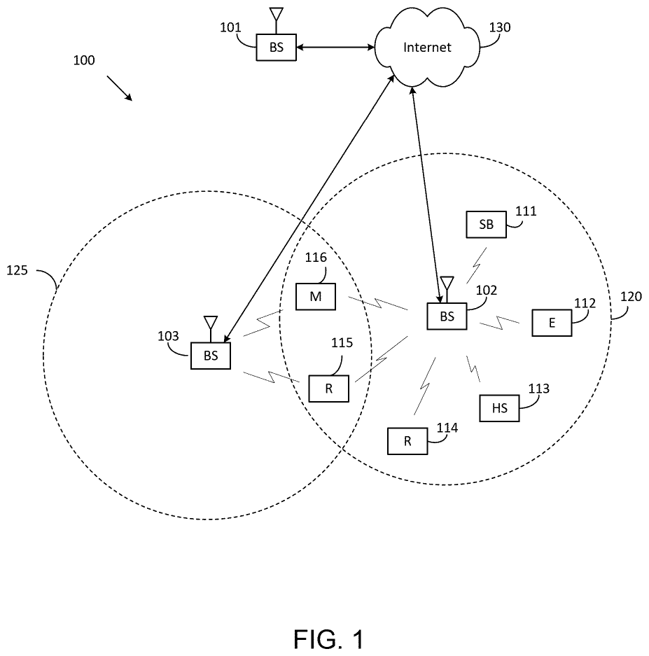

FIG. 1 through FIG. 30, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TS 38.211 v16.1.0, “NR; Physical channels and modulation”; 3GPP TS 38.212 v16.1.0, “NR; Multiplexing and Channel coding”; 3GPP TS 38.213 v16.1.0, “NR; Physical Layer Procedures for Control”; 3GPP TS 38.214 v16.1.0, “NR; Physical Layer Procedures for Data”; 3GPP TS 38.321 v16.1.0, “NR; Medium Access Control (MAC) protocol specification”; and 3GPP TS 38.331 v16.1.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably-arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M), such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3GPP NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for configuring and determining default beams in a wireless communication system. In certain embodiments, and one or more of the gNBs 101-103 includes circuitry, programing, or a combination thereof, for configuring and determining default beams in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

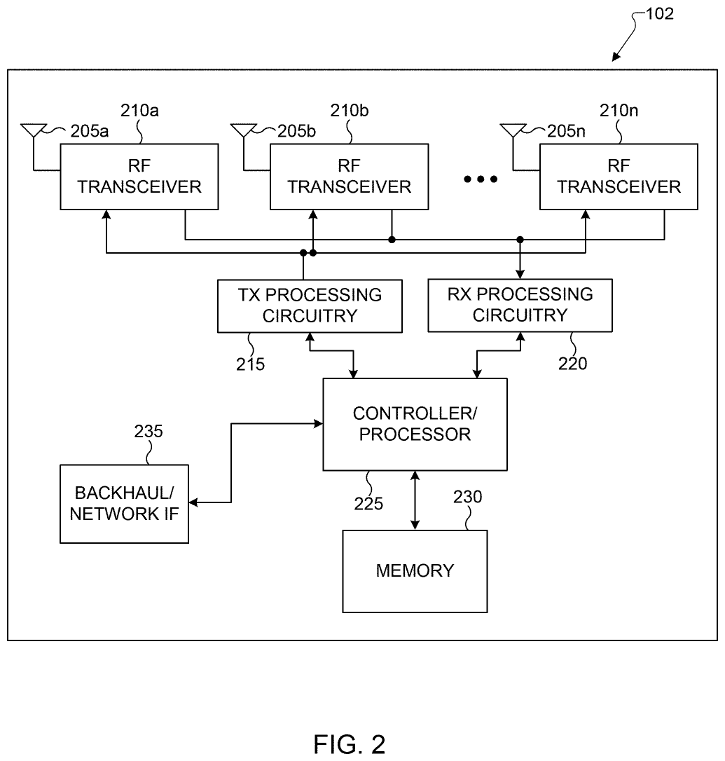

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple RF transceivers 210a-210n, transmit (TX) processing circuitry 215, and receive (RX) processing circuitry 220. The gNB 102 also includes a controller/processor 225, a memory 230, and a backhaul or network interface 235.

The RF transceivers 210a-210n receive, from the antennas 205a-205n, incoming RF signals, such as signals transmitted by UEs in the network 100. The RF transceivers 210a-210n down-convert the incoming RF signals to generate IF or baseband signals. The IF or baseband signals are sent to the RX processing circuitry 220, which generates processed baseband signals by filtering, decoding, and/or digitizing the baseband or IF signals. The RX processing circuitry 220 transmits the processed baseband signals to the controller/processor 225 for further processing.

The TX processing circuitry 215 receives analog or digital data (such as voice data, web data, e-mail, or interactive video game data) from the controller/processor 225. The TX processing circuitry 215 encodes, multiplexes, and/or digitizes the outgoing baseband data to generate processed baseband or IF signals. The RF transceivers 210a-210n receive the outgoing processed baseband or IF signals from the TX processing circuitry 215 and up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the RF transceivers 210a-210n, the RX processing circuitry 220, and the TX processing circuitry 215 in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or RF transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. As a particular example, an access point could include a number of interfaces 235, and the controller/processor 225 could support routing functions to route data between different network addresses. As another particular example, while shown as including a single instance of TX processing circuitry 215 and a single instance of RX processing circuitry 220, the gNB 102 could include multiple instances of each (such as one per RF transceiver). Also, various components in FIG. 2 could be combined, further subdivided, or omitted and additional components could be added according to particular needs.

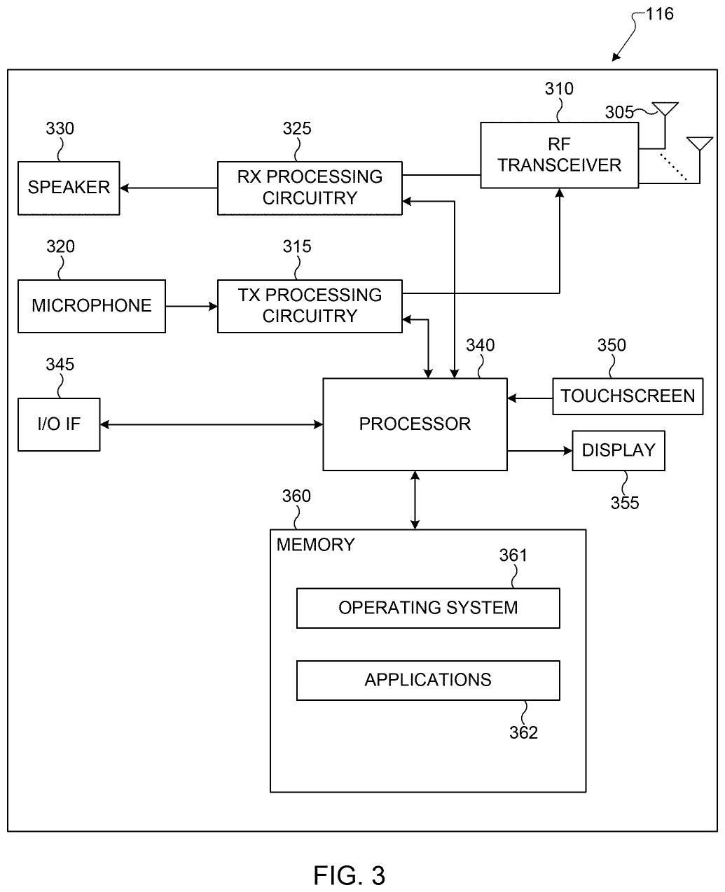

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes an antenna 305, a radio frequency (RF) transceiver 310, TX processing circuitry 315, a microphone 320, and receive (RX) processing circuitry 325. The UE 116 also includes a speaker 330, a processor 340, an input/output (I/O) interface (IF) 345, a touchscreen 350, a display 355, and a memory 360. The memory 360 includes an operating system (OS) 361 and one or more applications 362.

The RF transceiver 310 receives, from the antenna 305, an incoming RF signal transmitted by a gNB of the network 100. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data (such as web data, e-mail, or interactive video game data) from the processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the RF transceiver 310, the RX processing circuitry 325, and the TX processing circuitry 315 in accordance with well-known principles. In some embodiments, the processor 340 includes at least one microprocessor or microcontroller.

The processor 340 is also capable of executing other processes and programs resident in the memory 360, such as processes for configuring and determining default beams in a wireless communication system. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the touchscreen 350 and the display 355. The operator of the UE 116 can use the touchscreen 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). Also, while FIG. 3 illustrates the UE 116 configured as a mobile telephone or smartphone, UEs could be configured to operate as other types of mobile or stationary devices.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

A communication system includes a downlink (DL) that refers to transmissions from a base station or one or more transmission points to UEs and an uplink (UL) that refers to transmissions from UEs to a base station or to one or more reception points.

A time unit for DL signaling or for UL signaling on a cell is referred to as a slot and can include one or more symbols. A symbol can also serve as an additional time unit. A frequency (or bandwidth (BW)) unit is referred to as a resource block (RB). One RB includes a number of sub-carriers (SCs). For example, a slot can have duration of 0.5 milliseconds or 1 millisecond, include 14 symbols and an RB can include 12 SCs with inter-SC spacing of 15 KHz or 30 KHz, and so on.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format.

A gNB transmits one or more of multiple types of RS including channel state information RS (CSI-RS) and demodulation RS (DMRS). A CSI-RS is primarily intended for UEs to perform measurements and provide CSI to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources.

A UE can determine CSI-RS transmission parameters through DL control signaling or higher layer signaling, such as radio resource control (RRC) signaling, from a gNB. Transmission instances of a CSI-RS can be indicated by DL control signaling or be configured by higher layer signaling. A DM-RS is transmitted only in the BW of a respective PDCCH or PDSCH and a UE can use the DMRS to demodulate data or control information.

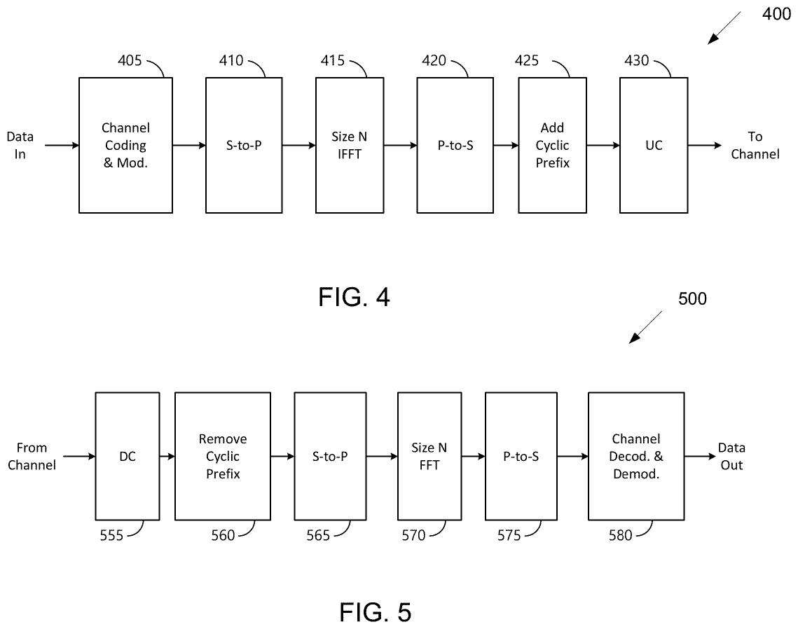

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to support the codebook design and structure for systems having 2D antenna arrays as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the down-converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIGS. 4 and FIG. 5 may be implemented in software, while other components may be implemented by configurable hardware or a mixture of software and configurable hardware. For instance, the FFT block 570 and the IFFT block 515 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

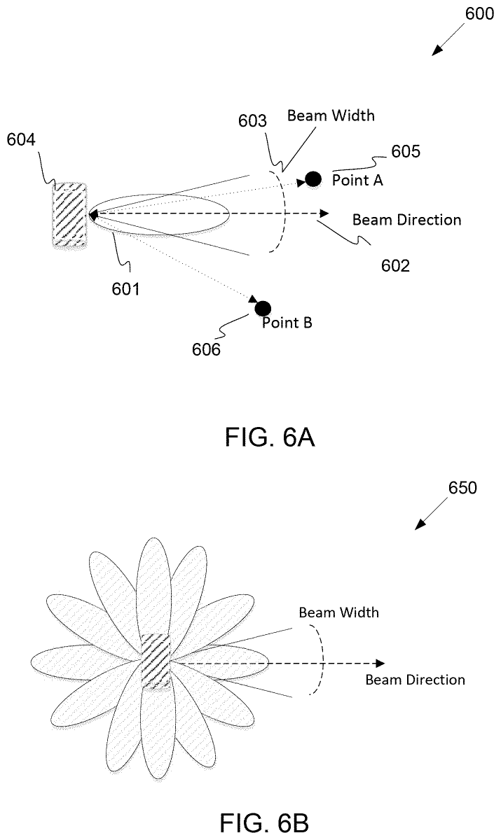

FIG. 6A illustrate an example wireless system beam 600 according to embodiments of the present disclosure. An embodiment of the wireless system beam 600 shown in FIG. 6A is for illustration only.

As illustrated in FIG. 6A, in a wireless system a beam 601, for a device 604, can be characterized by a beam direction 602 and a beam width 603. For example, a device 604 with a transmitter transmits radio frequency (RF) energy in a beam direction and within a beam width. The device 604 with a receiver receives RF energy coming towards the device in a beam direction and within a beam width. As illustrated in FIG. 6A, a device at point A 605 can receive from and transmit to the device 604 as Point A is within a beam width of a beam traveling in a beam direction and coming from the device 604.

As illustrated in FIG. 6A, a device at point B 606 cannot receive from and transmit to the device 604 as Point B is outside a beam width of a beam traveling in a beam direction and coming from the device 604. While FIG. 6A, for illustrative purposes, shows a beam in 2-dimensions (2D), it may be apparent to those skilled in the art, that a beam can be in 3-dimensions (3D), where the beam direction and beam width are defined in space.

FIG. 6B illustrate an example multi-beam operation 650 according to embodiments of the present disclosure. An embodiment of the multi-beam operation 650 shown in FIG. 6B is for illustration only.

In a wireless system, a device can transmit and/or receive on multiple beams. This is known as “multi-beam operation” and is illustrated in FIG. 6B. While FIG. 6B, for illustrative purposes, is in 2D, it may be apparent to those skilled in the art, that a beam can be 3D, where a beam can be transmitted to or received from any direction in space.

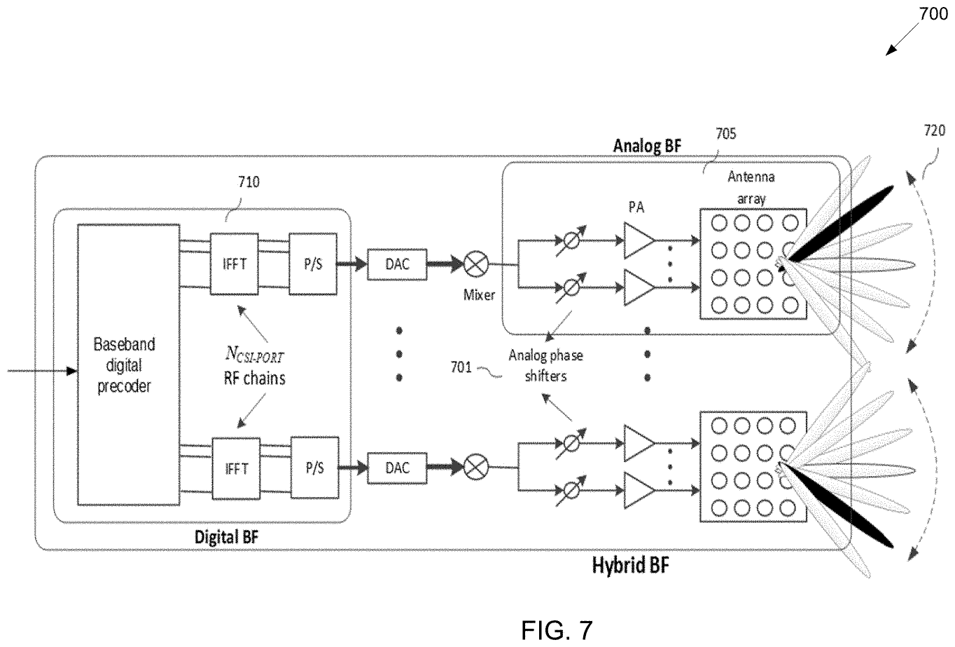

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated in FIG. 7.

FIG. 7 illustrate an example antenna structure 700 according to embodiments of the present disclosure. An embodiment of the antenna structure 700 shown in FIG. 7 is for illustration only.

In this case, one CSI-RS port is mapped onto a large number of antenna elements which can be controlled by a bank of analog phase shifters 701. One CSI-RS port can then correspond to one sub-array which produces a narrow analog beam through analog beamforming 705. This analog beam can be configured to sweep across a wider range of angles 720 by varying the phase shifter bank across symbols or subframes. The number of sub-arrays (equal to the number of RF chains) is the same as the number of CSI-RS ports N_{CSI-PORT}. A digital beamforming unit 710 performs a linear combination across N_{CSI-PORT} analog beams to further increase precoding gain. While analog beams are wideband (hence not frequency-selective), digital precoding can be varied across frequency sub-bands or resource blocks. Receiver operation can be conceived analogously.

Since the aforementioned system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam.

The aforementioned system is also applicable to higher frequency bands such as >52.6 GHz (also termed the FR4). In this case, the system can employ only analog beams. Due to the O2 absorption loss around 60 GHz frequency (˜10 dB additional loss @ 100 m distance), larger number of and sharper analog beams (hence larger number of radiators in the array) may be needed to compensate for the additional path loss.

A UE receives from the network downlink control information through one or more PDCCHs. The UE would use the downlink control information to configure one or more receive parameters/settings to decode subsequent downlink data channels (i.e., PDSCHs) transmitted from the network. Under certain settings, the UE could start receiving and/or decoding the PDSCH after the UE has decoded the PDCCH and obtained the corresponding control information.

In this case, the time offset between the reception of the PDCCH and the reception of the PDSCH exceeds a preconfigured threshold, which, e.g., could correspond to the time required for decoding the PDCCH and adjusting the receive parameters. The time offset between the receptions of the PDCCH and the PDSCH could be smaller than the threshold (e.g., the network could send the PDSCH close to the PDCCH in time or even overlapping with the PDCCH in time).

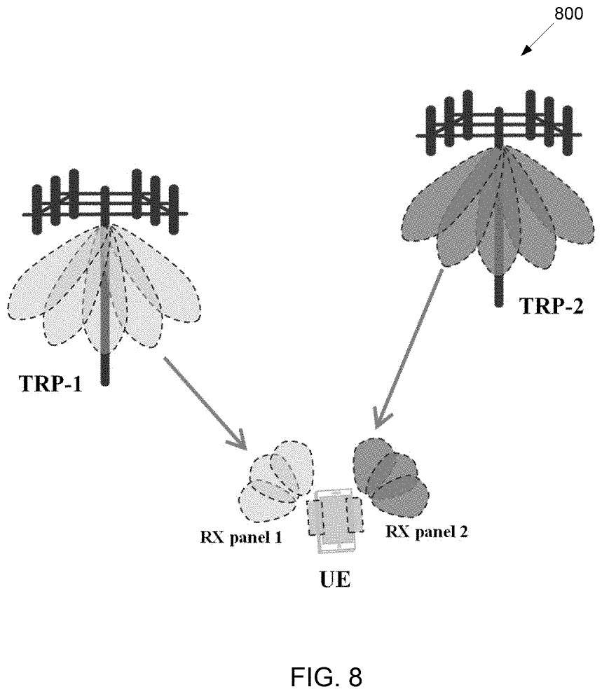

In this case, the UE may not be able to decode the PDSCH because the UE does not have enough time to decode the PDCCH to set appropriate receive parameters such as the receive spatial filter for receiving/decoding the PDSCH. Hence, there is a need to configure one or more default TCI states for the PDSCH transmission, and therefore, one or more default receive beams for the UE to buffer the PDSCH when the UE is in the process of receiving and/or decoding the PDCCH control information. In a multi-TRP system (depicted in FIG. 8), wherein the UE could simultaneously receive multiple PDSCHs from multiple physically non-co-located TRPs, the configuration of the default TCI state(s)/receive beam(s) could be different from that for the single-TRP operation. Further, the configurations of the default TCI state(s)/receive beam(s) could also be different between single-DCI (or single-PDCCH) and multi-DCI (or multi-PDCCH) based multi-TRP systems.

FIG. 8 illustrates an example of multi-TRP system 800 according to embodiments of the present disclosure. An embodiment of the multi-TRP system 800 shown in FIG. 8 is for illustration only.

For the single-PDCCH or single-DCI based multi-TRP operation, if the time offset between the reception of the PDCCH and the reception of the PDSCH is less than the threshold, the UE could assume that the DMRS ports of the PDSCH follow the QCL parameters indicated by the default TCI state(s), which could correspond to the lowest codepoint among the TCI codepoints containing two different TCI states activated for the PDSCH. For the multi-PDCCH or multi-DCI based multi-TRP operation (assuming that the CORESETPOOLIndex is configured), if the time offset between the reception of the PDCCH and the reception of the PDSCH is less than the threshold, the UE could assume that the DMRS ports of the PDSCH follow the QCL parameters indicated by the default TCI state(s), which could be used for the PDCCH with the lowest CORESET index among the CORESETs configured with the same value of CORESETPOOLIndex.

The default TCI state(s)/receive beam(s) configurations in the 3GPP Rel. 15/16 assume that the PDCCH and the PDSCH could employ different beams, and therefore, the UE could use different spatial filters to receive the PDCCH and the PDSCH beams. If a common TCI state/beam is used/configured for various types of channels such as PDCCH and PDSCH, the configuration of the default TCI state(s)/receive beam(s) could be different from the existing solutions (described above, relying on lowest CORESET ID/TCI codepoint). Further, whether the UE could simultaneously receive the PDSCHs transmitted from the coordinating TRPs may also be considered when configuring the default TCI state(s) for the multi-TRP operation.

The present disclosure considers various design options for configuring default TCI state(s)/receive beam(s) in both single-DCI and multi-DCI based multi-TRP systems. Specifically, the common TCI state/beam indication is used as the baseline framework to configure the default TCI state(s). The UE could also follow the legacy behavior(s) defined in the 3GPP Rel. 15/16 to determine the default receive beam(s) under certain settings/conditions, which are also discussed in this disclosure.

Furthermore, throughout the present disclosure, a common TCI state/beam is equivalent to a unified TCI state/beam or a Rel. 17 unified TCI state/beam. Under the Rel. 17 unified TCI framework, a UE could receive from the network a DCI format (e.g., DCI format 1_1 or 1_2 with or without DL assignment) indicating one or more Rel. 17 unified TCI states for various DL/UL channels and/or signals such as UE-dedicated reception on PDSCH/PDCCH or dynamic-grant/configured-grant based PUSCH and all of dedicated PUCCH resources.

For instance, the DCI format could include one or more “Transmission Configuration Indication” fields. A “Transmission Configuration Indication” field could carry a codepoint from the codepoints activated by a MAC CE activation command, and the codepoint could indicate at least one of: M≥1 joint DL and UL Rel. 17 unified TCI states or M≥1 separate UL Rel. 17 unified TCI states or a first combination of M≥1 joint DL and UL Rel. 17 unified TCI states and separate UL Rel. 17 unified TCI states or N≥1 separate DL Rel. 17 unified TCI states or a second combination of N≥1 joint DL and UL Rel. 17 unified TCI states and separate DL Rel. 17 unified TCI states or a third combination of N≥1 joint DL and UL Rel. 17 unified TCI states, separate DL Rel. 17 unified TCI states and separate UL Rel. 17 unified TCI states.

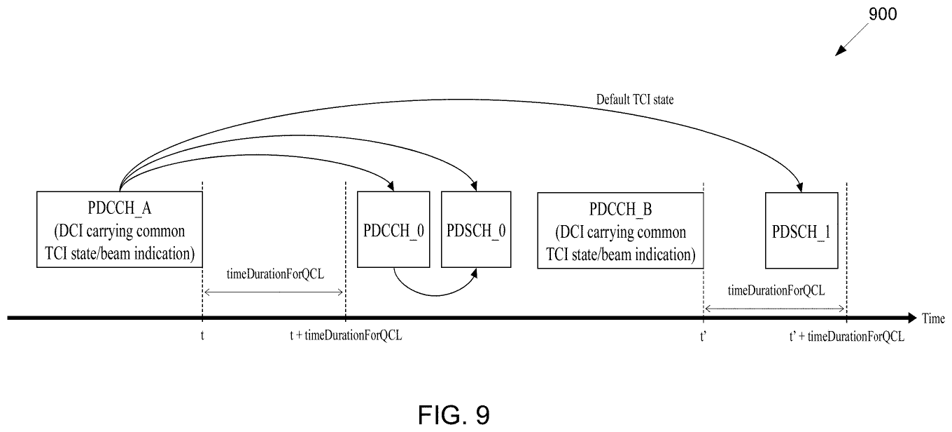

FIG. 9 illustrates an example of unified TCI state indication 900 according to embodiments of the present disclosure. An embodiment of the unified TCI state indication 900 shown in FIG. 9 is for illustration only.

The UE could be configured/indicated by the network a common TCI state/beam for various types of channels such as PDCCH and PDSCH. In FIG. 9, a conceptual example of using a DCI to indicate the common TCI for both the PDCCH and the PDSCH is presented. The common TCI signaled in the DCI at time t would become effective at t+timeDurationForQCL. As illustrated in the example shown in FIG. 9, the UE could be able to first decode PDCCH_A (conveying the DCI that indicates the common TCI) and obtain the necessary QCL parameters.

The UE could then follow the QCL parameters and set appropriate receive parameters such as the receive spatial filter to receive and decode PDCCH_0 and PDSCH_0. The UE, however, is not able to set the receive parameters according to the QCL configured in PDCCH_B (conveying the DCI that indicates the common TCI) to decode PDSCH_1 because the time offset between the reception of PDCCH_B and that of PDSCH_1 is less than timeDurationForQCL.

Hence, the UE may need to follow the QCL indications in the default TCI state to set appropriate receive parameters such as the receive spatial filter (default receive beam). For example, the default TCI state could correspond to the common TCI indicated/configured in PDCCH_A. There could be various other means to configure the default TCI state(s)/receive beam(s) depending on whether/how the common TCI state/beam is indicated and/or simultaneous PDSCH reception requirement for the multi-TRP operation.

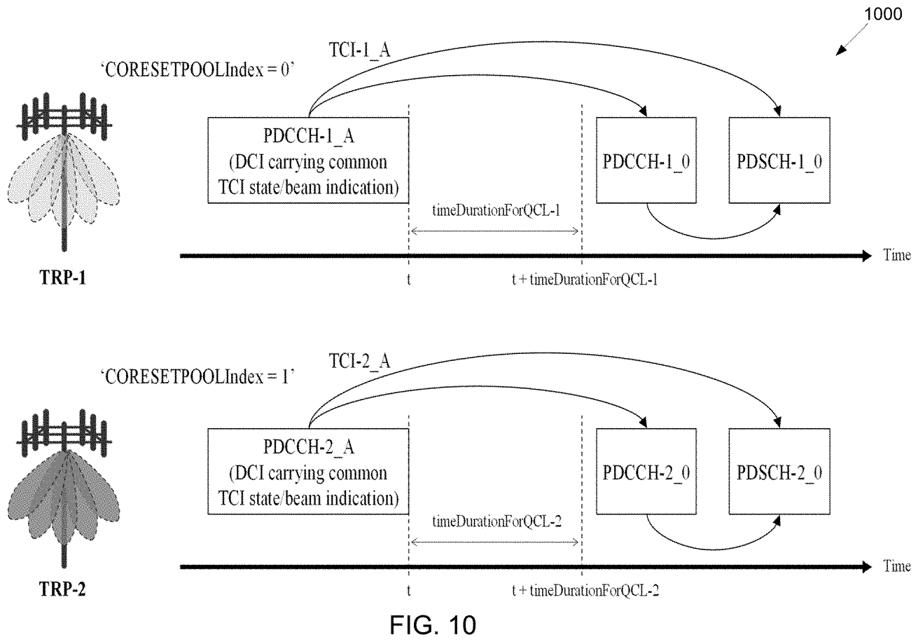

FIG. 10 illustrates an example of unified TCI state indication for a multi-DCI based multi-TRP system 1000 according to embodiments of the present disclosure. An embodiment of the unified TCI state indication for a multi-DCI based multi-TRP system 1000 shown in FIG. 10 is for illustration only.

In the multi-DCI based multi-TRP system, different coordinating TRPs (e.g., TRP-1 and TRP-2 in FIG. 8) could transmit to the UE separate PDCCHs (and therefore, separate PDSCHs) associated with different values of the higher layer signaling index CORESETPOOLIndex (if configured). For example, TRP-1 in FIG. 8 could transmit PDCCH-1 to the UE, and TRP-2 could transmit PDCCH-2 to the UE; PDCCH-1 could be associated with “CORESETPOOLIndex=0” while PDCCH-2 could be associated with “CORESETPOOLIndex=1.” Further, if the common TCI state/beam indication is enabled for the multi-TRP operation, the UE could be configured with multiple common TCI states/beams (N_tci>1), each corresponding to a coordinating TRP. Under the multi-DCI framework, the common TCI states/beams, and therefore, their indicating PDCCHs, could also be associated with the CORESETPOOLIndex.

In FIG. 10, a conceptual example characterizing the common TCI states/beams indication in a multi-TRP system comprising of two coordinating TRPs is provided. As illustrated in FIG. 10, PDCCH-1_A is from TRP-1 and indicates to the UE the common TCI state/beam from TRP-1 (TCI-1_A). Further, PDCCH-1_A is associated with “CORESETPOOLIndex=0.” PDCCH-1_B indicates to the UE the common TCI state/beam from TRP-2 (TCI-2_A), and is associated with “CORESETPOOLIndex=1.” The UE could set the receive spatial filter based on TCI-1_A for receiving and/or decoding PDCCH-1_0 and PDSCH-1_0 because the time offsets between them and PDCCH-1_A are less than timeDurationForQCL-1.

Similarly, the UE could also be able to set appropriate receive spatial filter to receive and/or decode PDCCH-2_0 and PDSCH-2_0 from TRP-2 as the UE could have enough time (time offsets are less than timeDurationForQCL-2) to decode PDCCH-2_A first and extract the necessary QCL configurations/assumptions for decoding the subsequent PDCCH/PDSCH transmissions. The two thresholds timeDurationForQCL-1 and timeDurationForQCL-2 for TRP-1 and TRP-2 could be common or different. For instance, the UE could use different receive panels with different array configurations to receive the PDCCHs/PDSCHs from different coordinating TRPs, resulting in different thresholds for different TRPs.

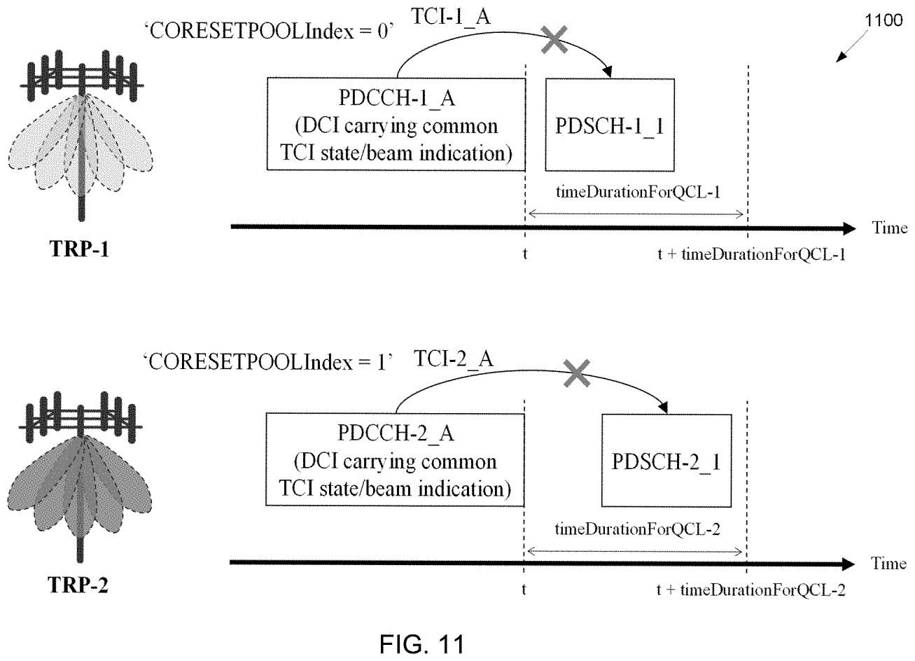

FIG. 11 illustrates another example of unified TCI state indication for a multi-DCI based multi-TRP system 1100 according to embodiments of the present disclosure. An embodiment of the unified TCI state indication for a multi-DCI based multi-TRP system 1100 shown in FIG. 11 is for illustration only.

In FIG. 11, another example depicting the common TCI states/beams indication in a multi-TRP system is presented. In this example, prior to fully decoding PDCCH-1_A, the UE would receive PDSCH-1_1 from TRP-1 (their time offset is less than timeDurationForQCL-1), and prior to fully decoding PDCCH-2_A, the UE would receive PDSCH-2_1 from TRP-2 (their time offset is less than timeDurationForQCL-2). In this case, the UE would need to set appropriate spatial receive filters (default receive beams) to buffer PDSCH-1_1 and PDSCH-2_1 without relying on the common TCI states/beams indicated in PDCCH-1_A and PDCCH-2_A. In the following, various design options to configure default TCI states/beams for the PDSCH transmissions (or equivalently, to determine default receive beams for the UE to buffer the PDSCHs) in the multi-DCI based multi-TRP system are presented.

In one example of Option-1, if the CORESETPOOLIndex is configured and the time offset between the reception of a first PDCCH carrying the common TCI state/beam indication (e.g., PDCCH-1_A in FIG. 11) and the reception of the PDSCH (e.g., PDSCH-1_1 in FIG. 9) is less than the threshold (e.g., timeDurationForQCL-1 in FIG. 11), the UE could assume that the QCL parameters for the DMRS ports of the PDSCH follow those of the default TCI state/beam, which could correspond to the previous common TCI state/beam indicated in a second PDCCH, which is associated with the same CORESETPOOLIndex (value) as that associated with the first PDCCH.

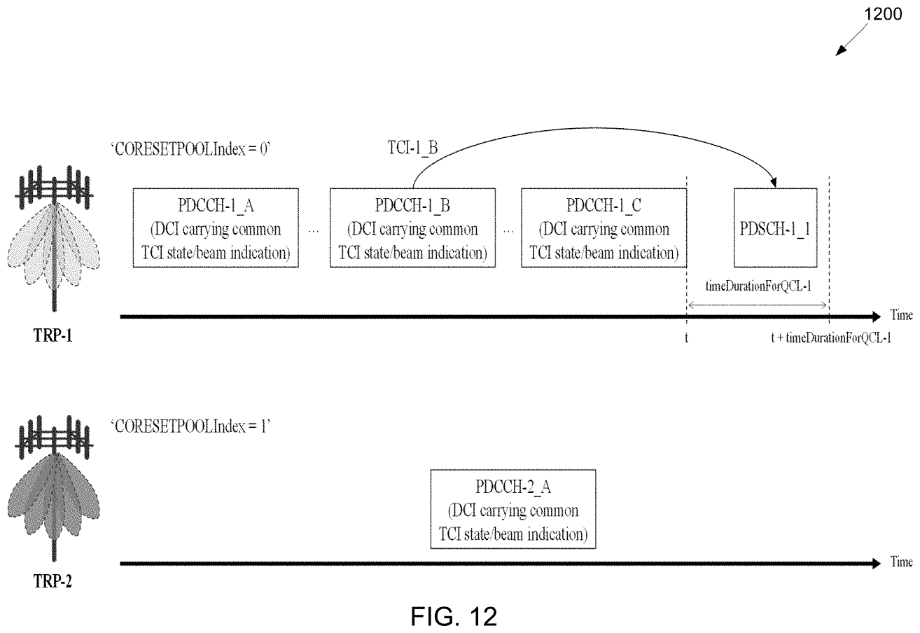

FIG. 12 illustrates yet another example of unified TCI state indication for a multi-DCI based multi-TRP system 1200 according to embodiments of the present disclosure. An embodiment of the unified TCI state indication for a multi-DCI based multi-TRP system 1200 shown in FIG. 12 is for illustration only.

In FIG. 12, a conceptual example illustrating Option-1 is given. As indicated in FIG. 12, the UE cannot use the common TCI state/beam indicated in PDCCH-1_C (the first PDCCH in Option-1) to set the receive parameter(s) for decoding PDSCH-1_1 because their time offset is less than timeDurationForQCL-1. According to Option-1, the default TCI state for PDSCH-1_1 in this example is the common TCI state (TCI-1_B) indicated in PDCCH-1_B (the second PDCCH in Option-1). This is because the time offset between the reception of PDCCH-1_B and that of PDSCH-1_1 is beyond timeDurationForQCL-1, and PDCCH-1_B and PDCCH-1_C share the same CORESETPOOLIndex (“0”), i.e., both of them are transmitted from the same TRP-1.

Furthermore, PDCCH-1_B is the closest to PDSCH-1_1 in time among all PDCCHs from TRP-1 that carry the common TCI state/beam indications and have been decoded by the UE. Note that in this case, the common TCI state/beam indicated in PDCCH-2_A cannot be configured as the default TCI state/beam for PDSCH-1_1 because the common TCI state/beam is associated with a different value of CORESETPOOLIndex (“1”).

In one example of Option-2, if the time offset between the reception of the PDCCH carrying the common TCI state/beam indication (e.g., PDCCH-1_A in FIG. 11) and the reception of the PDSCH (e.g., PDSCH-1_1 in FIG. 11) is less than the threshold (e.g., timeDurationForQCL-1 in FIG. 11), the UE could assume that the QCL parameters for the DMRS ports of the PDSCH follow those of the default TCI state/beam, which could correspond to the previous common TCI state/beam indicated to the UE regardless of the transmitting TRP. This design option does not depend on whether the CORESETPOOLIndex is configured.

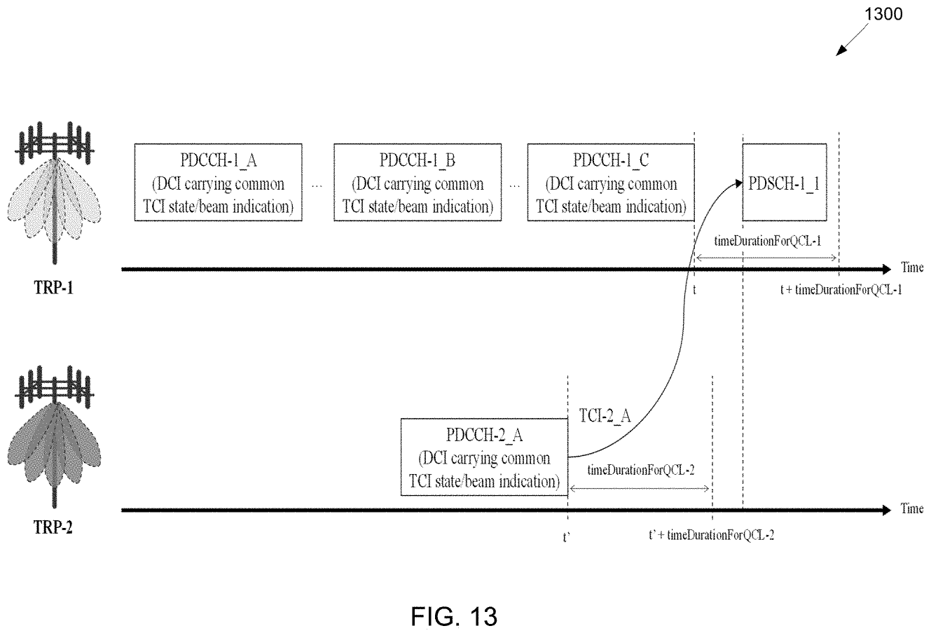

FIG. 13 illustrates yet another example of unified TCI state indication for a multi-DCI based multi-TRP system 1300 according to embodiments of the present disclosure. An embodiment of the unified TCI state indication for a multi-DCI based multi-TRP system 1300 shown in FIG. 13 is for illustration only.

In FIG. 13, a conceptual example characterizing Option-2 is provided. Different from the example for Option-1 shown in FIG. 12, the CORESETPOOLIndex is not configured for the multi-DCI based multi-TRP system. Hence, the default TCI state/beam for PDSCH-1_1 from TRP-1 could correspond to the previous common TCI state/beam indicated to the UE. In this example, the previous common TCI state/beam indicated to the UE is TCI-2_A indicated in PDCCH-2_A from TRP-2. That is, PDCCH-2_A is the closest PDCCH to PDSCH-1_1 in time among all the PDCCHs from both TRP-1 and TRP-2 that carry the common TCI state/beam indications and have been decoded by the UE.

In one example of Option-3, if the CORESETPOOLIndex is configured and the time offset between the reception of a first PDCCH carrying the common TCI state/beam indication (e.g., PDCCH-1_A in FIG. 11) and the reception of the PDSCH (e.g., PDSCH-1_1 in FIG. 11) is less than the threshold (e.g., timeDurationForQCL-1 in FIG. 11), the UE could assume that the QCL parameters for the DMRS ports of the PDSCH follow those of the default TCI state/beam, which could be used for the latest PDCCH carrying the common TCI state/beam indication (a third PDCCH) associated with the same CORESETPOOLIndex (value) as that associated with the first PDCCH.

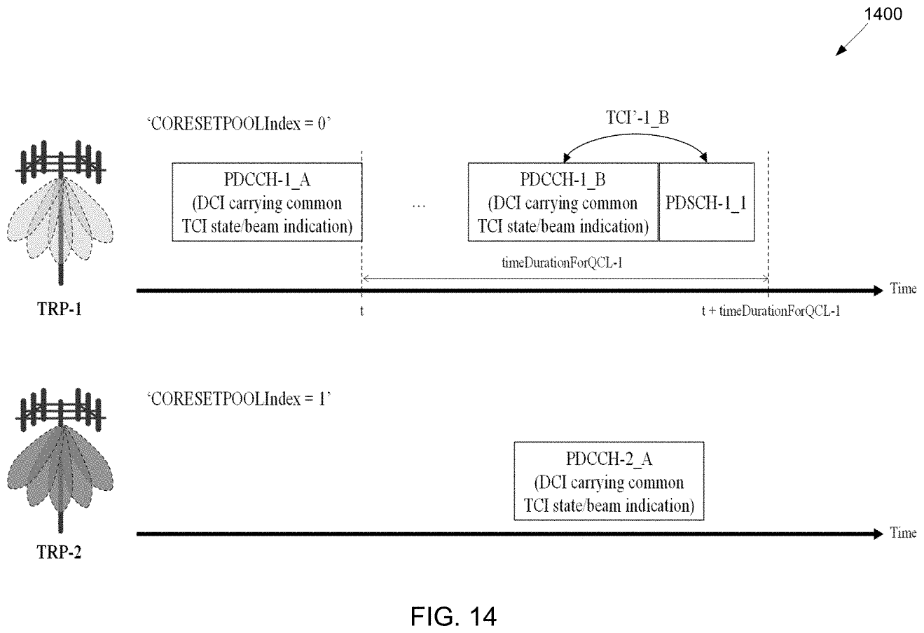

FIG. 14 illustrates yet another example of unified TCI state indication for a multi-DCI based multi-TRP system 1400 according to embodiments of the present disclosure. An embodiment of the unified TCI state indication for a multi-DCI based multi-TRP system 1400 shown in FIG. 14 is for illustration only.

In FIG. 14, a conceptual example of Option-3 default TCI state/beam configuration in a multi-DCI based multi-TRP system is presented. In this example, the UE cannot set the receive spatial filter to receive and/or decode PDSCH-1_1 according to the common TCI state/beam indicated in PDCCH-1_A because their time offset is less than timeDurationForQCL-1. The UE, however, could use the same spatial receive filter as that used for receiving PDCCH-1_B to receive and/or decode PDSCH-1_1. This is because for PDSCH-1_1, PDCCH-1_B is the latest PDCCH carrying the common TCI state/beam indication and shares the same CORESETPOOLIndex (value) with PDCCH-1_A.

Hence, based on Option-3, the UE would assume the same TCI state (and therefore the corresponding QCL parameters) for the DMRS ports of PDSCH-1_1 as that used for PDCCH-1_B (TCI′-1_B). Note that TCI′-1_B for PDCCH-1_B could be activated by MAC CE from a pool of TCI states configured by RRC signaling. Further, in this example, if PDCCH-1_B is not present, the TCI state used for PDCCH-1_A could be the default TCI state for PDSCH-1_1 because now PDCCH-1_A becomes the “third PDCCH” in Option-3.

In one example of Option-4, if the time offset between the reception of a first PDCCH carrying the common TCI state/beam indication (e.g., PDCCH-1_A in FIG. 11) and the reception of the PDSCH (e.g., PDSCH-1_1 in FIG. 11) is less than the threshold (e.g., timeDurationForQCL-1 in FIG. 11), the UE could assume that the QCL parameters for the DMRS ports of the PDSCH follow those of the default TCI state/beam, which could be used for the latest PDCCH carrying the common TCI state/beam indication (a fourth PDCCH) regardless of the transmitting TRP. This design option does not depend on whether the CORESETPOOLIndex is configured.

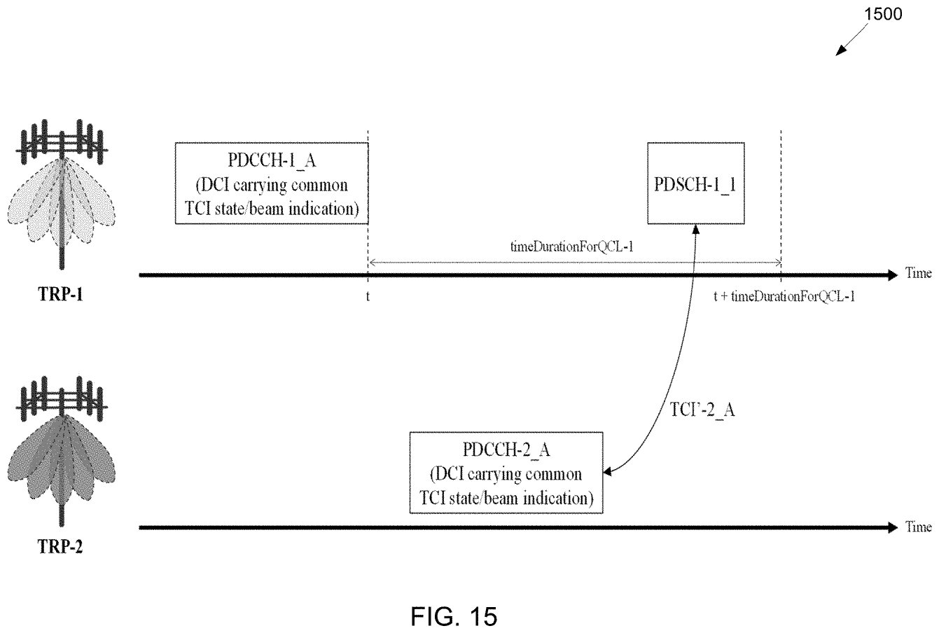

FIG. 15 illustrates yet another example of unified TCI state indication for a multi-DCI based multi-TRP system 1500 according to embodiments of the present disclosure. An embodiment of the unified TCI state indication for a multi-DCI based multi-TRP system 1500 shown in FIG. 15 is for illustration only.

The example shown in FIG. 15 assumes that the CORESETPOOLIndex is not configured, and the latest PDCCH that conveys the common TCI state/beam with respect to the PDSCH of interest, i.e., PDSCH-1_1 from TRP-1, is PDCCH-2_A from TRP-2. Based on Option-4, the default TCI state for PDSCH-1_1 could therefore be configured as TCI′-2_A used for PDCCH-2_A. That is, the UE could use the same receive parameters to receive PDSCH-1_1 as those used for receiving PDCCH-2_A.

In one example of Option-5, the configuration of the default TCI state/beam for PDSCH follows the legacy procedure defined in the 3GPP Rel. 16 for multi-DCI based multi-TRP. If the CORESETPOOLIndex is configured and the time offset between the reception of a first PDCCH carrying the common TCI state/beam indication (e.g., PDCCH-1_A in FIG. 11) and the reception of the PDSCH (e.g., PDSCH-1_1 in FIG. 11) is less than the threshold (e.g., timeDurationForQCL-1 in FIG. 11), the UE could assume that the QCL parameters for the DMRS ports of the PDSCH follow those of the default TCI state/beam, which could be used for the latest PDCCH with the lowest CORESET index among the CORESETs configured with the same value of CORESETPOOLIndex as that associated with the first PDCCH.

In one example of Option-6, the configuration of the default TCI state/beam for PDSCH follows the legacy procedure defined in the 3GPP Rel. 15. If the time offset between the reception of a first PDCCH carrying the common TCI state/beam indication (e.g., PDCCH-1_A in FIG. 11) and the reception of the PDSCH (e.g., PDSCH-1_1 in FIG. 11) is less than the threshold (e.g., timeDurationForQCL-1 in FIG. 11), the UE could assume that the QCL parameters for the DMRS ports of the PDSCH follow those of the default TCI state/beam, which could be used for the PDCCH with the lowest CORESET index among the CORESETs associated with a monitored search space in the latest slot. This design option does not depend on whether the CORESETPOOLIndex is configured.

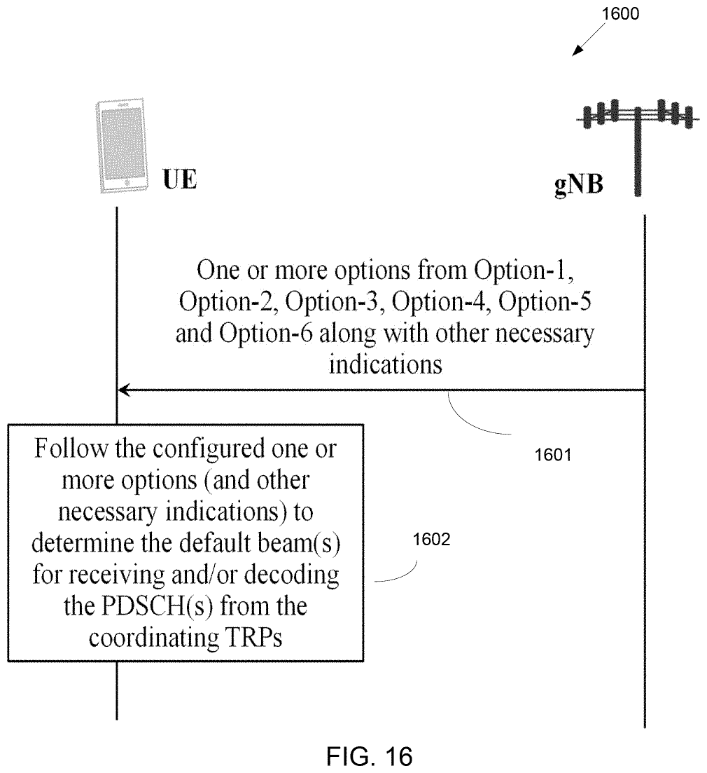

FIG. 16 illustrates an example of a signaling flow 1600 between a UE and a gNB according to embodiments of the present disclosure. For example, the signaling flow 1600 as may be performed by a UE (e.g., 111-116 as illustrated in FIG. 1) and a BS (e.g., 101-103 as illustrated in FIG. 1). An embodiment of the signaling flow 1600 shown in FIG. 16 is for illustration only. One or more of the components illustrated in FIG. 16 can be implemented in specialized circuitry configured to perform the noted functions or one or more of the components can be implemented by one or more processors executing instructions to perform the noted functions.

As illustrated in FIG. 16, in step 1601, a gNB indicates to a UE to apply one or more options from Option-1, Option-2, Option-3, Option-4, Option-5 and Option-6 presented in the present disclosure along with other necessary indications. In step 1602, a UE follows the configured one or more options (and other necessary indications) to determine the default beam(s) for receiving and/or decoding the PDSCH(s) from the coordinating TRPs.

The UE could be configured by the network one or more design options described above to configure the default beam(s) for receiving the PDSCH(s) in a multi-DCI based multi-TRP system (see FIG. 16). In the following, four configuration embodiments are discussed.

In one embodiment of Method-I: the UE is indicated by the network to follow only one design option, e.g., Option-1 in the present disclosure, to configure the default receive beam(s) for receiving and/or decoding the PDSCH(s). The configured design option applies to all of the coordinating TRPs in the multi-TRP system.

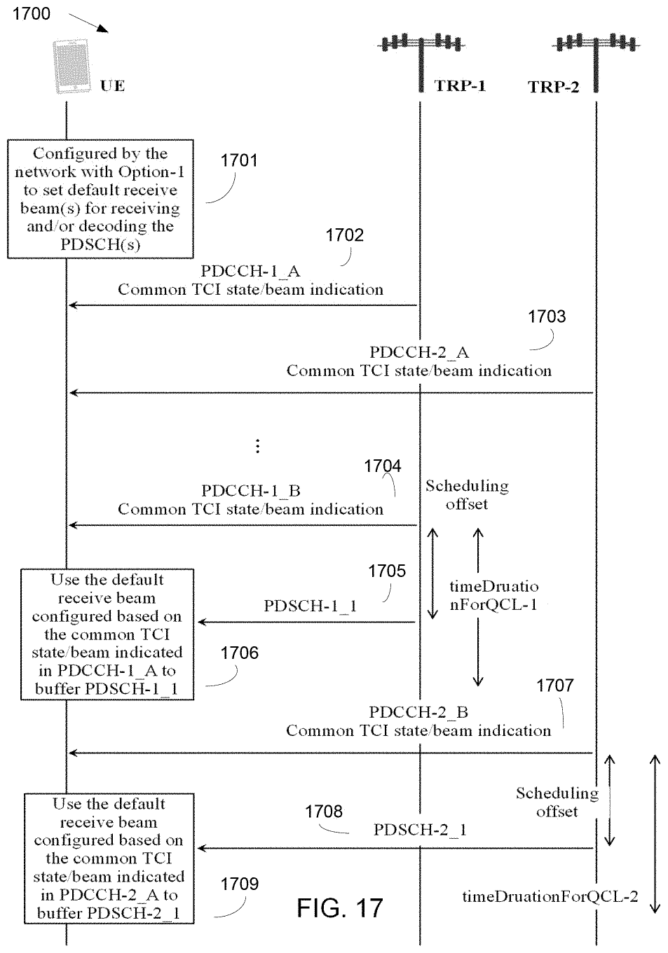

FIG. 17 illustrates an example of a signaling flow 1700 for configuring and determining a default TCI state according to embodiments of the present disclosure. For example, the signaling flow 1700 as may be performed by a UE (e.g., 111-116 as illustrated in FIG. 1) and BSs (e.g., 101-103 as illustrated in FIG. 1). An embodiment of the signaling flow 1700 shown in FIG. 17 is for illustration only. One or more of the components illustrated in FIG. 17 can be implemented in specialized circuitry configured to perform the noted functions or one or more of the components can be implemented by one or more processors executing instructions to perform the noted functions.

In FIG. 17, the signaling procedure of configuring and determining the default TCI state(s)/beam(s) following Option-1 for both coordinating TRPs (TRP-1 and TRP-2) in a multi-DCI based multi-TRP system is depicted. In this example, the UE is indicated by the network to only follow Option-1 to configure the default receive beams for receiving and/or decoding the PDSCHs from both TRP-1 and TRP-2. For instance, according to Option-1, the UE would configure the receive spatial filter following the QCL parameters of the common TCI state/beam indicated in PDCCH_1-A to buffer PDSCH_1-1 from TRP-1. This is because the scheduling offset between PDCCH_1-B and PDSCH_1-1 is less than timeDurationForQCL-1 and PDCCH_1-A is the previous PDCCH that carries a common TCI state/beam indication. Similarly, the UE would configure the receive spatial filter following the QCL parameters of the common TCI state/beam indicated in PDCCH_2-A to buffer PDSCH_2-1 from TRP-2.

As illustrated in FIG. 17, in step 1701, a UE is configured by the network with Option-1 to set default receive beam(s) for receiving and/or decoding the PDSCH(s). In step 1702, a TRP-1 sends a PDCCH-1_A common TCI state/beam indication to the UE. In step 1703, a TRP-2 sends a PDCCH-2_A common TCI state/beam indication to the UE. In step 1704, the TRP-1 sends PDCCH-1_B common TCI state/beam indication to the UE. In step 1705, TRP-1 sends PDSCH-1_1 to the UE. In step 1706, the UE uses the default receive beam configured based on the common TCI state/beam indicated in PDCCH-1_A to buffer PDSCH-1_1. In step 1707, the TRP-2 sends PDCCH-2_B common TCI state/beam indication to the UE. In step 1708, the TRP-2 sends PDSCH-2_1 to the UE. In step 1709, the UE uses the default receive beam configured based on the common TCI state/beam indicated in PDCCH-2_A to buffer PDSCH-2_1.

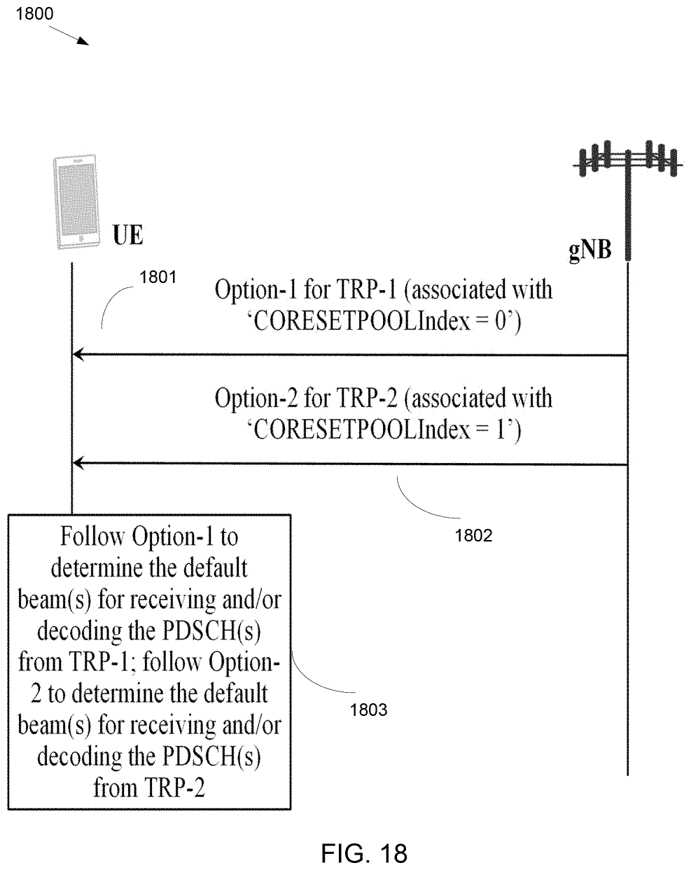

FIG. 18 illustrates an example of a signaling flow 1800 between a UE and a gNB according to embodiments of the present disclosure. For example, the signaling flow 1800 as may be performed by a UE (e.g., 111-116 as illustrated in FIG. 1) and a BS (e.g., 101-103 as illustrated in FIG. 1). An embodiment of the signaling flow 1800 shown in FIG. 18 is for illustration only. One or more of the components illustrated in FIG. 18 can be implemented in specialized circuitry configured to perform the noted functions or one or more of the components can be implemented by one or more processors executing instructions to perform the noted functions.

As illustrated in FIG. 18, in step 1801, a UE receives an indication from a gNB to use Option-1 for TRP-1 (associated with “CORESETPOOLIndex=0”). In step 1802, the gNB indicates to the UE to use Option-2 for TRP-2 (associated with “CORESETPOOLIndex=1”). In step 1803, the UE follows Option-1 to determine the default beam(s) for receiving and/or decoding the PDSCH(s) from TRP-1; and follows Option-2 to determine the default beam(s) for receiving and/or decoding the PDSCH(s) from TRP-2.

In one embodiment of Method-II, the UE is indicated by the network to follow only one design option per TRP, or per CORESETPOOLIndex, to configure the default receive beam(s) for receiving and/or decoding the PDSCH(s). The design options configured for different TRPs (or different values of CORESETPOOLIndex) could be different. For instance, for a multi-DCI based multi-TRP system comprising of two coordinating TRPs (TRP-1 and TRP-2), the UE could be indicated by the network to follow Option-1 to configure the default receive beam for buffering the PDSCH from TRP-1, and Option-2 to configure the default receive beam for buffering the PDSCH from TRP-2 (see FIG. 18).

For another example, assuming that the common TCI state/beam indication is enabled for TRP-1 but not for TRP-2, the UE could be indicated by the network to follow Option-1 to configure the default receive beam for buffering the PDSCH from TRP-1, and Option-5 to configure the default receive beam for buffering the PDSCH from TRP-2.

In one embodiment of Method-III, the UE is configured by the network more than one (N_opt>1) design options, e.g., Option-1 and Option-2. Further, the UE is configured by the network a priority rule and/or a set of conditions. Based on the priority rule and/or the set of conditions, the UE could determine an appropriate design option (out of all the configured design options) to follow to configure the default receive beam(s) for buffering the PDSCH(s). The configured design options along with the priority rule and/or the set of conditions are common for all the coordinating TRPs in the multi-TRP system.

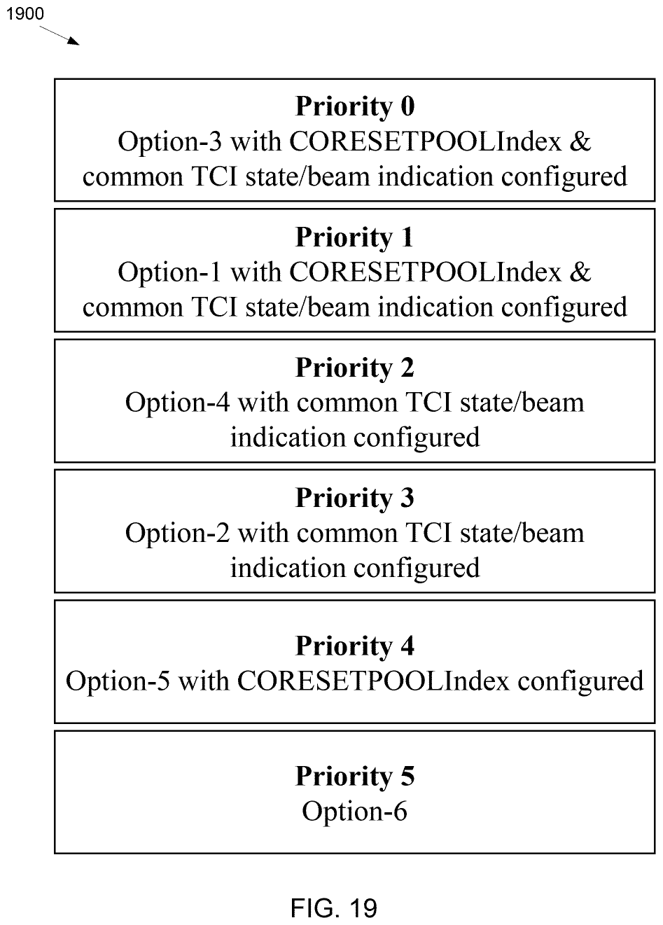

FIG. 19 illustrates an example of priority rule for configuring and determining default TCI state 1900 according to embodiments of the present disclosure. An embodiment of the priority rule for configuring and determining default TCI state 1900 shown in FIG. 19 is for illustration only.

In FIG. 19, one example depicting the priority rule/order is presented. In the diagram shown in FIG. 19, Priority 0 is the highest priority and Priority 5 is the lowest priority. Option-3 has the highest priority in this example, followed by Option-1, Option-4, Option-2, Option-5, and Option-6 has the lowest priority. For instance, if the UE is configured by the network with both Option-3 and Option-2, the UE would follow Option-3 to set the default receive beam(s) for buffering the PDSCH(s) if the CORESETPOOLIndex is configured. Otherwise, if the CORESETPOOLIndex is not configured, the UE would follow Option-2 to set the default receive beam(s) for buffering the PDSCH(s).

For another example, assume that the UE is configured by the network with Option-2, Option-5 and Option-6. If the common TCI state/beam indication is configured/enabled, regardless of whether the CORESETPOOLIndex is configured, the UE would follow Option-2 to configure the default receive beam(s). If the common TCI state/beam indication is not configured/enabled but the CORESETPOOLIndex is configured, the UE would follow Option-5 to set the default receive beam(s). Otherwise, the UE would fall back to Option-6 to set the default receive beam(s) for buffering the PDSCH(s). Other priority rules/orderings than that shown in FIG. 19 are also possible.

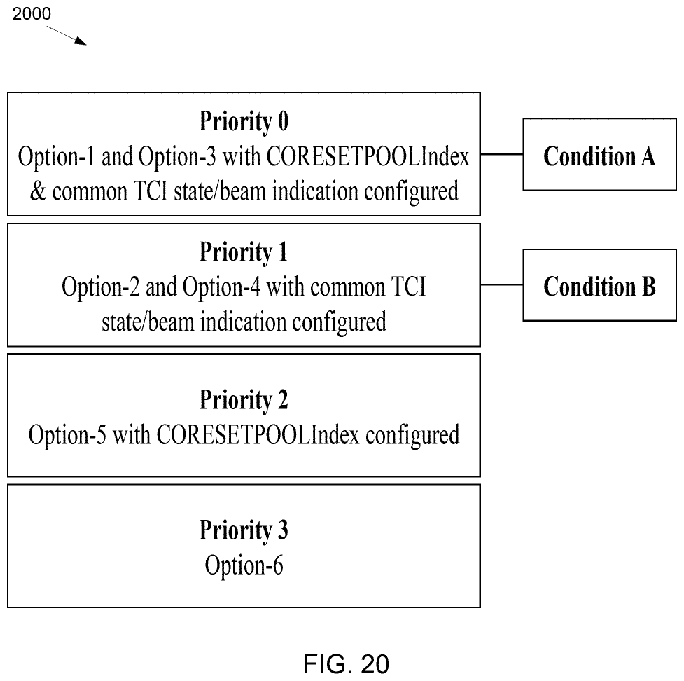

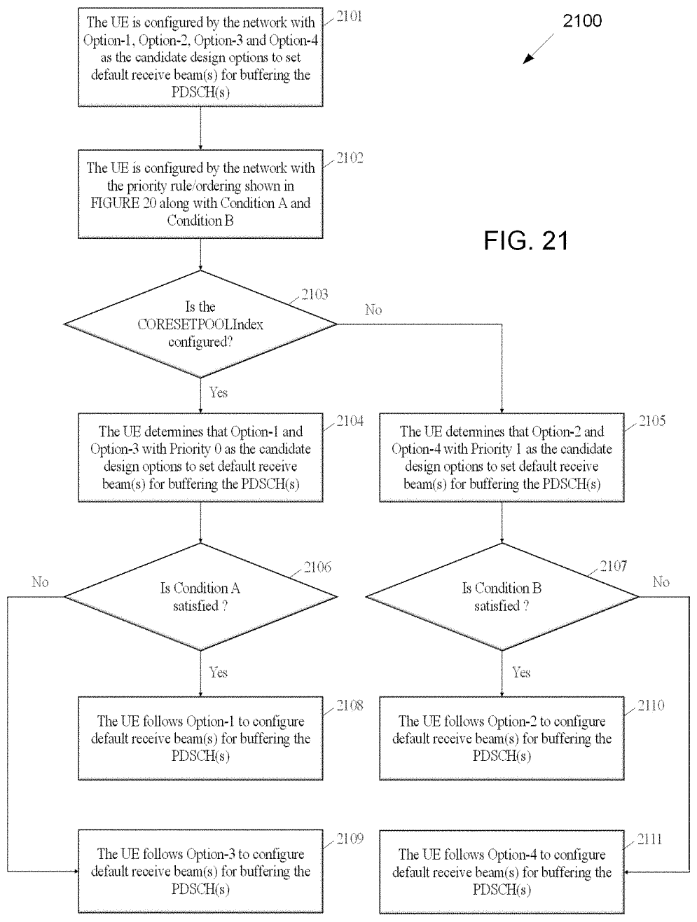

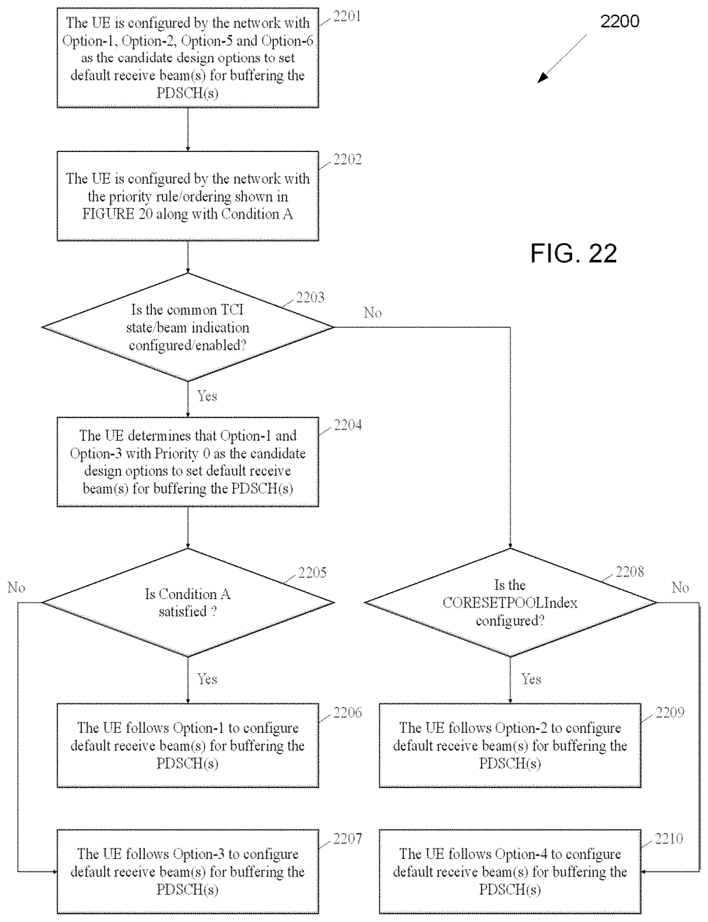

FIG. 20 illustrates another example of priority rule for configuring and determining default TCI state 2000 according to embodiments of the present disclosure. An embodiment of the priority rule for configuring and determining default TCI state 2000 shown in FIG. 20 is for illustration only.

In FIG. 20, another example of priority rule/ordering is given. In this example, Option-1 and Option-3 have the same priority, and Option-2 and Option-4 have the same priority. Hence, the network may be better not to configure the design options with the same priority (e.g., Option-1 and Option-3) to the UE, unless the UE could rely on other criteria/conditions to prioritize them.

Based on the above embodiments and examples, in addition to the priority rule/ordering, the UE could also be indicated by the network a set of conditions. The UE could decide the appropriate design option (out of the total configured design options) based on the indicated conditions to set the default receive beam(s) for receiving/buffering the PDSCH(s). As indicated in FIG. 20, Condition A is associated with Priority 0 to differentiate between Option-1 and Option-3, and Condition B is associated with Priority 1 to differentiate between Option-2 and Option-4. For instance, if Condition A is satisfied, the UE would choose Option-1 over Option-3 as the design option to follow to set the appropriate default receive beam(s). Otherwise, the UE would follow Option-3.

Similarly, if Condition B is satisfied, the UE would follow Option-2 to configure the default receive beam(s) for buffering the PDSCH(s).

FIG. 21 illustrates a flowchart of a UE method 2100 for receiving and decoding PDSCH according to embodiments of the present disclosure. For example, the UE method 2100 as may be performed by a UE (e.g., 111-116 as illustrated in FIG. 1). An embodiment of the UE method 2100 shown in FIG. 21 is for illustration only. One or more of the components illustrated in FIG. 21 can be implemented in specialized circuitry configured to perform the noted functions or one or more of the components can be implemented by one or more processors executing instructions to perform the noted functions.

In FIG. 21, an algorithm flowchart illustrating the above described procedures is presented assuming that the UE is configured by the network with Option-1, Option-2, Option-3 and Option-4 as the candidate design options to set the default receive beam(s) for receiving and/or decoding the PDSCH(s).

As illustrated in FIG. 21, in step 2101, a UE is configured by the network with Option-1, Option-2, Option-3, and Option-4 as the candidate design options to set default receive beam(s) for buffering the PDSCH(s). In step 2102, the UE is configured by the network with the priority rule/ordering shown in FIG. 20 along with Condition A and Condition B. In step 2103, the UE determines whether the CORESETPOOLIndex is configured. In step 2104, the UE determines that Option-1 and Option-3 with Priority 0 as the candidate design options to set default receive beam(s) for buffering the PDSCH(s). In step 2105, the UE determines that Option-2 and Option-4 with Priority 1 as the candidate design options to set default receive beam(s) for buffering the PDSCH(s). In step 2106, the UE determines whether the Condition A is satisfied. In step 2107, the UE determines whether the Condition B is satisfied. In step 2108, the UE follows Option-1 to configure default receive beam(s) for buffering the PDSCH(s). In step 2109, the UE follows Option-3 to configure default receive beam(s) for buffering the PDSCH(s). In step 2110, the UE follows Option-2 to configure default receive beam(s) for buffering the PDSCH(s). In step 2111, the UE follows Option-4 to configure default receive beam(s) for buffering the PDSCH(s).

FIG. 22 illustrates another flowchart of a UE method 2200 for receiving and decoding PDSCH according to embodiments of the present disclosure. For example, the UE method 2200 as may be performed by a UE (e.g., 111-116 as illustrated in FIG. 1). An embodiment of the UE method 2200 shown in FIG. 22 is for illustration only. One or more of the components illustrated in FIG. 22 can be implemented in specialized circuitry configured to perform the noted functions or one or more of the components can be implemented by one or more processors executing instructions to perform the noted functions.

In FIG. 22, another algorithm flowchart is depicted assuming that the UE is configured by the network with Option-1, Option-2, Option-5 and Option-6 as the candidate design options. As can be seen from FIG. 22, besides checking whether the CORESETPOOLIndex is configured or not, no additional conditions are needed to prioritize between Option-5 and Option-6.

As illustrated in FIG. 22, in step 2201, a UE is configured by the network with Option-1, Option-2, Option-5, and Option-6 as the candidate design options to set default receive beam(s) for buffering the PDSCH(s). In step 2202, a UE is configured by the network with the priority rule/ordering shown in FIG. 20 along with Condition A. In step 2203, the UE determines whether the common TCI state/beam indication is configured/enabled. In step 2204, the UE determines that Option-1 and Option-3 with Priority 0 as the candidate design options to set default receive beam(s) for buffering the PDSCH(s). In step 2205, the UE determines whether the Condition A is satisfied. In step 2206, the UE follows Option-1 to configure default receive beam(s) for buffering the PDSCH(s). In step 2207, the UE follows Option-3 to configure default receive beam(s) for buffering the PDSCH(s). In step 2208, the UE determines whether the CORESETPOOLIndex is configured. In step 2209, the UE follows Option-2 to configure default receive beam(s) for buffering the PDSCH(s). In step 2210, the UE follows Option-4 to configure default receive beam(s) for buffering the PDSCH(s).

Condition A and/or Condition B shown in FIG. 20 could correspond to a variety of possible conditions as shown below.

In one embodiment, Condition A is used for prioritizing between Option-1 and Option-3 under Priority 0 in FIG. 20.

In one example of Condition A.1, if the time offset between the PDSCH of interest and the previous PDCCH (the second PDCCH in Option-1, which shares the same CORESETPOOLIndex with the first PDCCH and has been decoded by the UE) carrying the common TCI state/beam indication is below a threshold (e.g., X ms/slots/symbols), Option-1 has a higher priority than Option-3.

In one example of Condition A.2, if the time offset between the PDSCH of interest and the previous PDCCH (the second PDCCH in Option-1, which shares the same CORESETPOOLIndex with the first PDCCH and has been decoded by the UE) carrying the common TCI state/beam indication is below a threshold (e.g., X ms/slots/symbols), but the receive beam configured according to the common TCI state/beam indicated in the second PDCCH and that used for receiving the latest PDCCH that carries the common TCI state/beam indication (the third PDCCH in Option-3) are from different panels, Option-3 has a higher priority than Option-1.

In one example of Condition A.3, if the UE could simultaneously receive the common beam indicated in the second PDCCH and the current beam from a different CORESETPOOLIndex (TRP), Option-1 has a higher priority than Option-3.

In one example of Condition A.4, if the UE could simultaneously receive the third PDCCH and the current beam from a different CORESETPOOLIndex (TRP), Option-3 has a higher priority than Option-1.

In one embodiment, Condition B is used for prioritizing between Option-2 and Option-4 under Priority 1 in FIG. 20.

In one example of Condition B.1, if the time offset between the PDSCH of interest and the previous PDCCH carrying the common TCI state/beam indication (which has been decoded by the UE) is below a threshold (e.g., X ms/slots/symbols), Option-2 has a higher priority than Option-4.

In one example of Condition B.2, if the time offset between the PDSCH of interest and the previous PDCCH carrying the common TCI state/beam indication (which has been decoded by the UE) is below a threshold (e.g., X ms/slots/symbols), but the receive beam configured according to the common TCI state/beam indicated in the previous PDCCH and that used for receiving the latest PDCCH that carries the common TCI state/beam indication (the fourth PDCCH in Option-4) are from different panels, Option-4 has a higher priority than Option-2.

Note that other conditions to Condition A.1, Condition A.2, Condition A.3, Condition B.1, and Condition B.2 are also possible. For Condition A.2 and Condition B.2, the UE may report to the network the receive antenna panel information such as panel ID along with the channel measurement report. For Condition A.3 and Condition A.4, a certain level of backhaul coordination between the TRPs is needed as one TRP may need to know the current transmit beam from another TRP (associated with a different value of CORESETPOOLIndex).

The UE could be configured by the network with all necessary conditions described above. The UE could then be indicated by the network to use one or more of them. For instance, the UE could be indicated by the network to only use Condition A.1 if both Option-1 and Option-3 are configured, though the UE could be configured by the network with Condition A.1, Condition A.2, Condition A.3, Condition A.4, Condition A.5, Condition B.1 and Condition B.2.

In some cases, the UE may not be configured by the network any priority rule/ordering (e.g., FIG. 19 and FIG. 20), but instead a set of explicit conditions along with the configured design options.

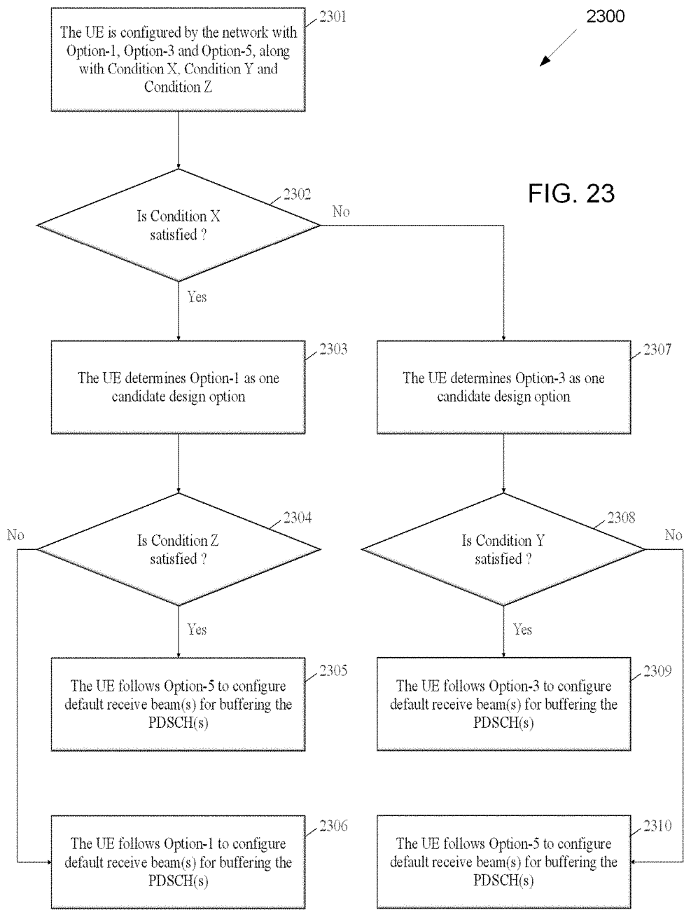

For instance, the UE could be first configured by the network three options, Option-1, Option-3 and Option-5. Further, the UE could be configured by the network three conditions, denoted by Condition X, Condition Y and Condition Z. If Condition X is satisfied, the UE would follow Option-1 over Option-3. If Condition Y is satisfied, the UE would follow Option-3 over Option-5. If Condition Z is satisfied, Option-5 has a higher priority than Option-1. One example charactering how the UE would determine the appropriate design option (from Option-1, Option-3 and Option-5) according to the configured conditions (Condition X, Condition Y and Condition Z) is shown in FIG. 23.

FIG. 23 illustrates yet another flowchart of a UE method 2300 for receiving and decoding PDSCH according to embodiments of the present disclosure. For example, the UE method 2300 as may be performed by a UE (e.g., 111-116 as illustrated in FIG. 1). An embodiment of the UE method 2300 shown in FIG. 23 is for illustration only. One or more of the components illustrated in FIG. 23 can be implemented in specialized circuitry configured to perform the noted functions or one or more of the components can be implemented by one or more processors executing instructions to perform the noted functions.

As indicated in FIG. 23, the UE could follow Option-5 instead of Option-1 and Option-3 to configure the default receive beam(s) for receiving the PDSCHs, which is not possible if the UE is configured and follows the priority rules/orderings in FIG. 19 and FIG. 20.

As illustrated in FIG. 23, in step 2301, a UE is configured by the network with Option-1, Option-3, and Option-5, along with Condition X, Condition Y and Condition Z. In step 2302, the UE determines whether Condition X is satisfied. In step 2303, the UE determines Option-1 as one candidate design option. In step 2304, the UE determines whether Condition Z is satisfied. In step 2305, the UE follows Option-5 to configure default receive beam(s) for buffering the PDSCH(s). In step 2306, the UE follows Option-1 to configure default receive beam(s) for buffering the PDSCH(s). In step 2307, the UE determines Option-3 as one candidate design option. In step 2308, the UE determines whether Condition Y is satisfied. In step 2309, the UE follows Option-3 to configure default receive beam(s) for buffering the PDSCH(s). In step 2310, the UE follows Option-5 to configure default receive beam(s) for buffering the PDSCH(s).

For example, Condition Z in FIG. 23 could be: if the time offset between the PDSCH of interest and the previous PDCCH (the second PDCCH in Option-1, which shares the same CORESETPOOLIndex with the first PDCCH and has been decoded by the UE) carrying the common TCI state/beam indication is below a threshold (e.g., X ms/slots/symbols), Option-1 has a higher priority than Option-5. Otherwise, the UE would follow Option-5 over Option-1 to configure the default receive beam(s), which was used for receiving the latest PDCCH with the lowest CORESET index among the CORESETs configured with the same value of CORESETPOOLIndex as that associated with the first PDCCH.

In one embodiment of Method-IV, the UE is configured by the network more than one (N_opt>1) design options per TRP (or per CORESETPOOLIndex). The design options configured for different TPRs could be mutually exclusive. For instance, if the CORESETPOOLIndex is configured, the UE could be configured with Option-1 and Option-3 for TRP-1 (associated with “CORESETPOOLIndex=0”) and Option-2 and Option-5 for TRP-2 (associated with “CORESETPOOLIndex=1”). Similar to Method-III, the UE could be indicated by the network one or more priority rules/orderings and/or one or more sets of conditions to help UE determine appropriate design option for each coordinating TRP. The priority rules/orderings and/or the sets of conditions could be common for all TRPs, are customized on a per TRP basis. Detailed methods of configuring and using the priority rules/orderings and/or the sets of conditions follow those described in FIG. 19, FIG. 20, FIG. 21, FIG. 22, and FIG. 23 in the present disclosure.

In the single-DCI based multi-TRP system, the UE could be configured by the network a single PDCCH/DCI to schedule the PDSCH transmissions from different coordinating TRPs. For common TCI state(s)/beam(s) indication, the corresponding PDCCH could signal N_tci>1 common TCI states/beams, each corresponding to a coordinating TRP. For instance, for a multi-TRP system comprising of two coordinating TRPs (e.g., TRP-1 and TRP-2 in FIG. 8), the TCI codepoint in the PDCCH that indicates the common TCI state(s)/beam(s) to the UE could be formulated as (TCI #a, TCI #b), where TCI #a could represent the common TCI state for TRP-1, and TCI #b could be the common TCI state for TRP-2. Similar to the example shown in FIG. 11 for the multi-DCI based multi-TRP system, the UE would also need to set the default receive beam(s) for buffering the PDSCH(s) in the single-DCI based multi-TRP system if the scheduling offset between the PDSCH(s) of interest and the PDCCH carrying the common TCI state(s)/beam(s) indication is less than a predetermined threshold.

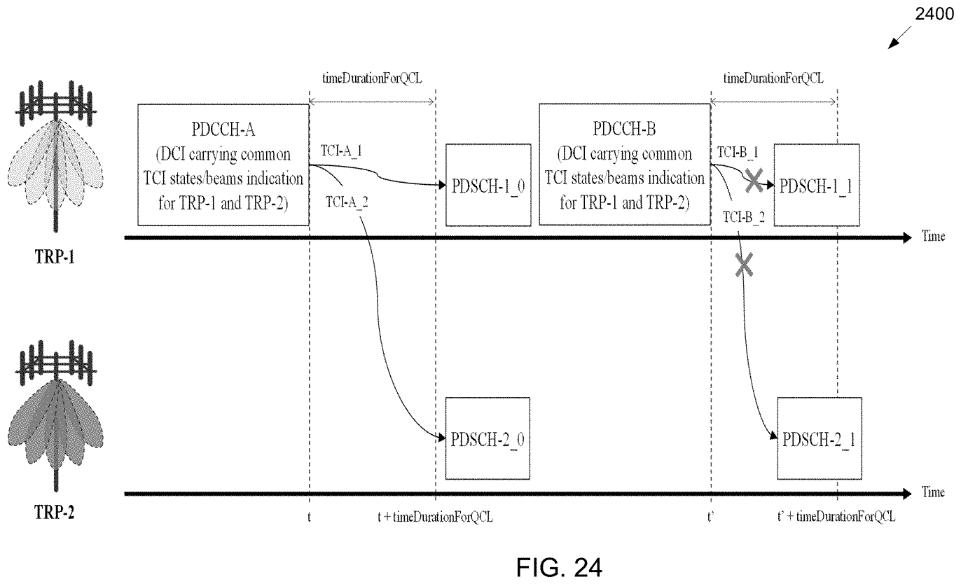

FIG. 24 illustrates an example of unified TCI state indication in a single-DCI based multi-TRP system 2400 according to embodiments of the present disclosure. An embodiment of the unified TCI state indication in a single-DCI based multi-TRP system 2400 shown in FIG. 24 is for illustration only.

In FIG. 24, a conceptual example depicting the common TCI state/beam indication in the single-DCI based multi-TRP system is presented. It is shown in FIG. 24 that the scheduling offset between PDSCH-1_0/PDSCH-2_0 and PDCCH-A carrying the common TCI states/beams for both TRP-1 and TRP-2 is beyond timeDurationForQCL. Hence, the UE could configure the receive spatial filters for receiving and/or decoding PDSCH-1_0 and PDSCH-2_0 based on the QCL parameters in TCI-A_1 and TCI-A_2 indicated in PDCCH-A. The scheduling offset between PDSCH-1_1/PDSCH-2_1 and PDCCH-B carrying the common TCI states/beams for both TRP-1 and TRP-2, however, is below the threshold timeDurationForQCL.

In this case, the UE is not able to set the receive spatial filters for receiving and/or decoding PDSCH-1_1 and PDSCH-2_1 according to the QCL parameters of TCI-B_1 and TCI-B_2 indicated in PDCCH-B. Hence, the UE needs to configure appropriate default receive beams for buffering PDSCH-1_1 and PDSCH-2_1. In the following, several design options of configuring and determining default TCI states/receive beams in the single-DCI based multi-TRP system with common TCI state/beam indication are discussed.

In one example of Option-A, if the time offsets between the reception of a first PDCCH carrying the common TCI states/beams for all the coordinating TRPs (e.g., PDCCH-B in FIG. 24) and the receptions of the PDSCHs (e.g., PDSCH-1_1 and PDSCH-2_1 in FIG. 24) are less than the threshold (e.g., timeDurationForQCL in FIG. 24), the UE could assume that the QCL parameters for the DMRS ports of the PDSCHs follow those of the default TCI states/beams, which could correspond to the previous N_tci (>1) TCI states/beams (not common TCI states/beams) indicated in a single DCI for all the PDSCHs transmitted from the coordinating TRPs.

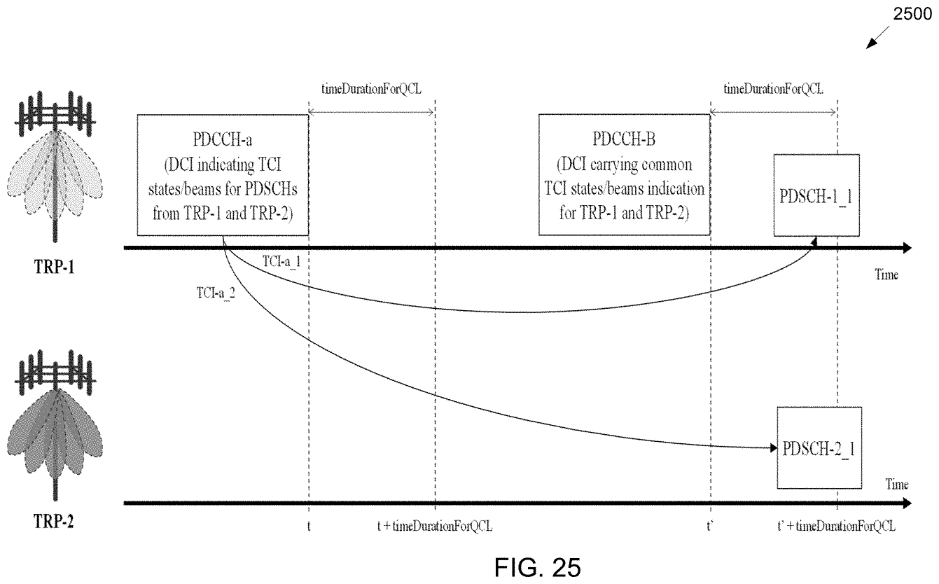

FIG. 25 illustrates another example of unified TCI state indication in a single-DCI based multi-TRP system 2500 according to embodiments of the present disclosure. An embodiment of the unified TCI state indication in a single-DCI based multi-TRP system 2500 shown in FIG. 25 is for illustration only.

In FIG. 25, a conceptual example describing the provided Option-A is presented. In this example, PDCCH-a is the previous PDCCH with respect to PDCCH-B that signals the DCI that indicates two TCI states, i.e., TCI-a_1 and TCI-a_2, for the PDSCHs transmitted from TRP-1 and TRP-2. For instance, (TCI-a_1, TCI-a_2) could correspond to one of the TCI codepoints (e.g., a total of eight TCI codepoints specified in the 3GPP Rel. 16) activated by MAC CE from a pool of TCI states configured by RRC.

As the scheduling offsets between PDSCH-1_1 and PDCCH-B, and PDSCH-2_1 and PDCCH-B, are less than timeDurationForQCL, the UE cannot configure the receive spatial filters for receiving PDSCH-1_1 and PDSCH-2_1 according to the QCL parameters of the common TCI states/beams indicated in PDCCH-B. According to Option-A, the UE would set the default receive beams for buffering PDSCH-1_1 and PDSCH-2_1 based on the QCL parameters of the TCI states/beams indicated in PDCCH-a.

In one example of Option-B, if the time offsets between the reception of a first PDCCH carrying the common TCI states/beams for all the coordinating TRPs (e.g., PDCCH-B in FIG. 24) and the receptions of the PDSCHs (e.g., PDSCH-1_1 and PDSCH-2_1 in FIG. 24) are less than the threshold (e.g., timeDurationForQCL in FIG. 24), the UE could assume that the QCL parameters for the DMRS ports of the PDSCHs follow those of the default TCI states/beams, which could correspond to the previous N_tci (>1) common TCI states/beams indicated in a single DCI for all the coordinating TRPs.

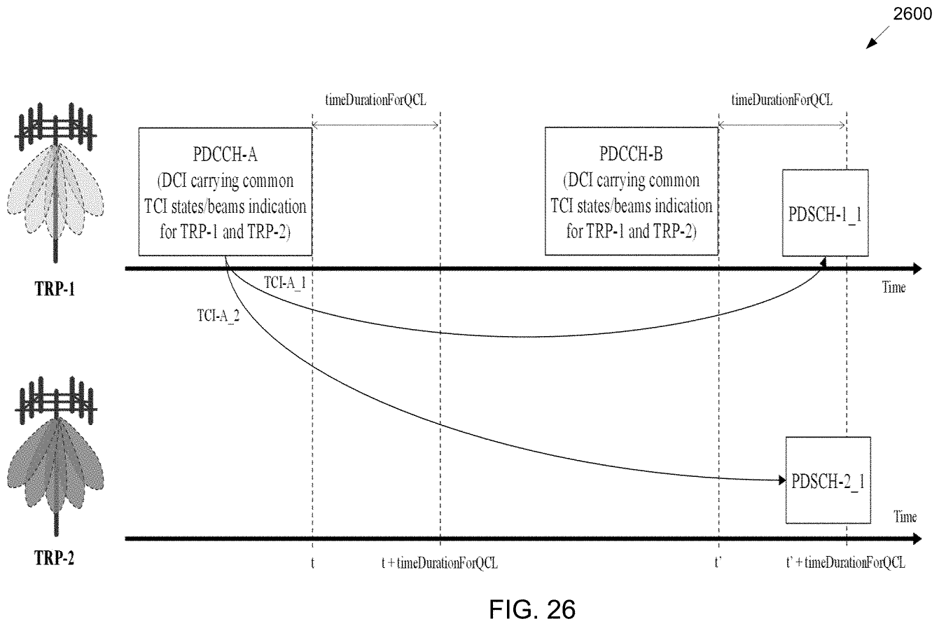

FIG. 26 illustrates yet another example of unified TCI state indication in a single-DCI based multi-TRP system 2600 according to embodiments of the present disclosure. An embodiment of the unified TCI state indication in a single-DCI based multi-TRP system 2600 shown in FIG. 26 is for illustration only.

A conceptual example illustrating the provided Option-B in configuring and determining the default receive beams is given in FIG. 26. Different from the example for Option-A shown in FIG. 25, the UE in FIG. 26 would configure the default receive beams for buffering PDSCH-1_1 and PDSCH-2_1 based on the QCL parameters of the two common TCI states, TCI-A_1 and TCI-A_2, indicated in PDCCH-A. This is because in this example, TCI-A_1 and TCI-A_2 are the previous common TCI states (with respect to those indicated in PDCCH-B) indicated in a single DCI (PDCCH-A) for all the coordinating TRPs (TRP-1 and TRP-2).

In one example of Option-C, if the time offsets between the reception of a first PDCCH carrying the common TCI states/beams for all the coordinating TRPs (e.g., PDCCH-B in FIG. 24) and the receptions of the PDSCHs (e.g., PDSCH-1_1 and PDSCH-2_1 in FIG. 24) are less than the threshold (e.g., timeDurationForQCL in FIG. 24), the UE could assume that the QCL parameters for the DMRS ports of the PDSCHs follow those of the default TCI states/beams, which could correspond to the lowest codepoint among the TCI codepoints containing N_tci (>1) different TCI states activated for the PDSCH. This design option is similar to the configuration of the default TCI state specified in the 3GPP Rel. 16 for the single-DCI based multi-TRP system.

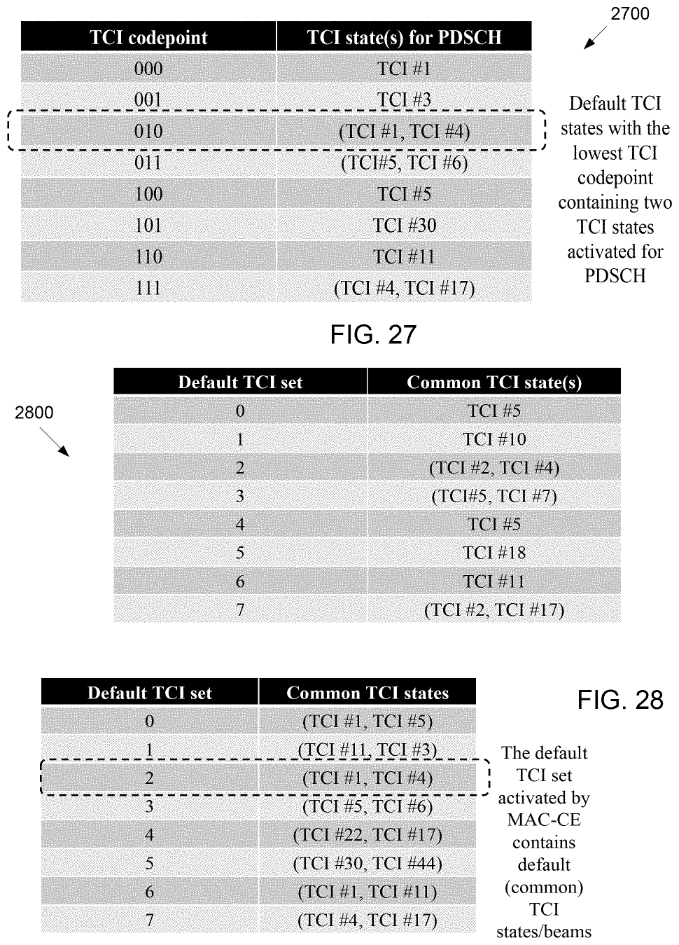

FIG. 27 illustrates an example of configuring and determining default TCI states 2700 according to embodiments of the present disclosure. An embodiment of configuring and determining the default TCI states 2700 shown in FIG. 27 is for illustration only.

As can be seen from the example shown in FIG. 27, a total of 8 TCI codepoints are activated for PDSCH by MAC CE from a pool of TCI states configured by RRC. Each TCI codepoint corresponds to one or two TCI states. According to Option-C, the default TCI states/beams would correspond to the lowest TCI codepoint containing two different TCI states. In this example, the default TCI states are then TCI #1 and TCI #4, and the corresponding TCI codepoint is “010.” The UE would configure the default receive beams for buffering the PDSCHs (e.g., PDSCH-1_1 and PDSCH-2_1 in FIG. 24) based on the QCL parameters of TCI #1 and TCI #4.

In one example of Option-D, if the time offsets between the reception of a first PDCCH carrying the common TCI states/beams for all the coordinating TRPs (e.g., PDCCH-B in FIG. 24) and the receptions of the PDSCHs (e.g., PDSCH-1_1 and PDSCH-2_1 in FIG. 24) are less than the threshold (e.g., timeDurationForQCL in FIG. 24), the UE could assume that the QCL parameters for the DMRS ports of the PDSCHs follow those of the default TCI states/beams, which could be configured by the network and indicated to the UE.

For instance, the UE could be explicitly configured/indicated by the network N_tci (>1) common TCI states/beams as the default TCI states/beams, upon which the UE could configure the receive spatial filters for buffering the PDSCHs transmitted from the coordinating TRPs. For a multi-TRP system comprising of two TRPs (TRP-1 and TRP-2), the UE could be configured by the network (TCI #1, TCI #4) as the default common TCI states. The UE would configure the default receive beams for buffering the PDSCHs (e.g., PDSCH-1_1 and PDSCH-2_1 in FIG. 24) based on the QCL parameters of TCI #1 and TCI #4 until the default common TCI states are updated/reconfigured by the network.

For another example, the UE could be configured by the network via higher layer signaling such as RRC a pool of default TCI sets. Each default TCI set could correspond to a single common TCI state, or N_tci (>1) common TCI states. The MAC CE could activate one of the default TCI sets, and the UE could configure the default receive beam(s) for buffering the PDSCH(s) according to the QCL parameters of the common TCI state(s) indicated in the activated default TCI set.

FIG. 28 illustrates another example of configuring and determining default TCI states 2800 according to embodiments of the present disclosure. An embodiment of configuring and determining the default TCI states 2800 shown in FIG. 28 is for illustration only.

In FIG. 28, two examples of the default TCI sets are presented. On the upper-half of FIG. 27, a default TCI set could contain a single common TCI state (e.g., for the single-TRP operation) or two common TCI states (e.g., for the multi-TRP operation). One the lower-half of FIG. 27, a default TCI set contains two common TCI states. If the MAC CE activates the default TCI set #2 as shown on the lower-half of FIG. 27, the UE would configure the default receive beams for buffering the PDSCHs (e.g., PDSCH-1_1 and PDSCH-2_1 in FIG. 24) based on the QCL parameters of TCI #1 and TCI #4 until the MAC CE activates a new default TCI set.

In one example of Option-E, the configuration of the default TCI state(s)/beam(s) for PDSCH follows the legacy procedure defined in the 3GPP Rel. 15. If the time offset between the reception of a first PDCCH carrying the common TCI states/beams for all the coordinating TRPs (e.g., PDCCH-B in FIG. 24) and the receptions of the PDSCHs (e.g., PDSCH-1_1 and PDSCH-2_1 in FIG. 24) are less than the threshold (e.g., timeDurationForQCL in FIG. 24), the UE could assume that the QCL parameters for the DMRS ports of the PDSCHs follow those of the default TCI state(s)/beam(s), which could be used for the PDCCH with the lowest CORESET index among the CORESETs associated with a monitored search space in the latest slot.

The UE could be configured by the network one or more design options described above to configure the default beam(s) for receiving the PDSCH(s) in a single-DCI based multi-TRP system. For instance, the UE could be indicated by the network to follow only one design option, e.g., Option-A, to configure the default receive beam(s) for receiving and/or decoding the PDSCH(s). For another example, the UE could be indicated by the network more than one design options along with a priority rule/ordering and/or a set of conditions, upon which the UE could determine and follow an appropriate design option to configure the default receive beam(s) for buffering the PDSCH(s).

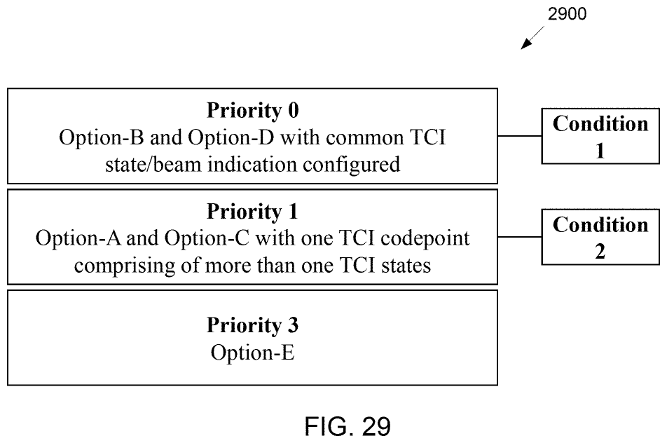

FIG. 29 illustrates an example of priority rule for configuring and determining default TCI state 2900 according to embodiments of the present disclosure. An embodiment of the priority rule for configuring and determining default TCI state 2900 shown in FIG. 29 is for illustration only.

A priority rule/ordering example is given in FIG. 29, in which Priority 0 has the highest priority while Priority 3 has the lowest priority. In this example, Option-B and Option-D belong to Priority 0, Option-A and Option-C belong to Priority 1, and Option-E corresponds to Priority 3. For instance, if the UE is indicated by the network Option-A and Option-B, the UE would follow Option-B to configure the default receive beam(s) as long as the common TCI state/beam indication is configured/enabled. For another example, assume that the UE is indicated by the network Option-C and Option-E. The UE would follow Option-E to set the default receive beam(s) if all of the TCI codepoints activated by the MAC CE comprise of a single TCI state.

Under certain settings, the UE could be indicated/configured by the network the design options that belong to the same priority order, e.g., Option-B and Option-D in the example shown in FIG. 29. In this case, the UE needs additional indications/conditions from the network so that the UE could prioritize one option over the other. In this example, the UE would be indicated by the network Condition 1 if the UE is configured with both Option-B and Option-D. Similarly, the UE would be indicated by the network Condition 2 if the UE is configured with both Option-A and Option-C. In the following, several possibilities for Condition 1 and Condition 2 are presented.

In one embodiment, Condition 1 is used for prioritizing between Option-B and Option-D under Priority 0 in FIG. 29.

In one example of Condition 1.1, if the UE is explicitly configured by the network the default (common) TCI states/beams (e.g., activating a default TCI set from a pool of default TCI sets each comprising of N_tci>1 common TCI states), Option-D has a higher priority than Option-B.

In one example of Condition 1.2, it may be assumed that the UE is explicitly configured by the network the default (common) TCI states/beams. If the previous N_tci (>1) common TCI states/beams (indicated in the single DCI for all the coordinating TRPs) are different from the explicitly configured default (common) TCI states and/or configured at a later time, Option-B has a higher priority than Option-D.

In one example of Condition 1.3, if the receive default beam(s) configured according to Option-B and the beam for receiving the first PDCCH are from different panels, meanwhile the receive default beam(s) configured following Option-D and the beam for receiving the first PDCCH are from the same panel, Option-D has a higher priority than Option-B.

In one example of Condition 1.4, if the receive default beam(s) configured according to Option-D and the beam for receiving the first PDCCH are from different panels, meanwhile the receive default beam(s) configured following Option-B and the beam for receiving the first PDCCH are from the same panel, Option-B has a higher priority than Option-D.

In one embodiment, Condition 2 is used for prioritizing between Option-A and Option-C under Priority 1 in FIG. 29.

In one example of Condition 2.1, if there is at least one TCI codepoint activated for PDSCH comprising of N_tci (>1) TCI states, Option-A has a higher priority than Option-C.

In one example of Condition 2.2, it may be assumed that there is at least one TCI codepoint activated for PDSCH comprising of N_tci (>1) TCI states. If the previous N_tci (>1) TCI states/beams (not common TCI states/beams) indicated in the single DCI for all the coordinating TRPs are different from those corresponding to the lowest TCI codepoint among all the TCI codepoints comprising of N_tci (>1) TCI states and/or configured at a later time, Option-C has a higher priority than Option-A.

In one example of Condition 2.3, if the receive default beam(s) configured according to Option-A and the beam for receiving the first PDCCH are from different panels, meanwhile the receive default beam(s) configured following Option-C and the beam for receiving the first PDCCH are from the same panel, Option-C has a higher priority than Option-A.

In one example of Condition 2.4, if the receive default beam(s) configured according to Option-C and the beam for receiving the first PDCCH are from different panels, meanwhile the receive default beam(s) configured following Option-A and the beam for receiving the first PDCCH are from the same panel, Option-A has a higher priority than Option-C.

Other priority rules/orderings than that shown in FIG. 29 are also possible. Further, other conditions than those described above can be implemented as well. Note that for Condition 1.3, Condition 1.4, Condition 2.3 and Condition 2.4, the UE may need to report to the network their receive panel information such as panel ID along with the channel measurement report. The UE could be configured by the network with all necessary conditions described above. The UE could then be indicated by the network to use one or more of them. For instance, the UE could be indicated by the network to only use Condition 1.1 if both Option-B and Option-D are configured, though the UE could be configured by the network with Condition 1.1, Condition 1.2, Condition 1.3, Condition 1.4, Condition 2.1, Condition 2.2, Condition 2.3 and Condition 2.4 in the first place.

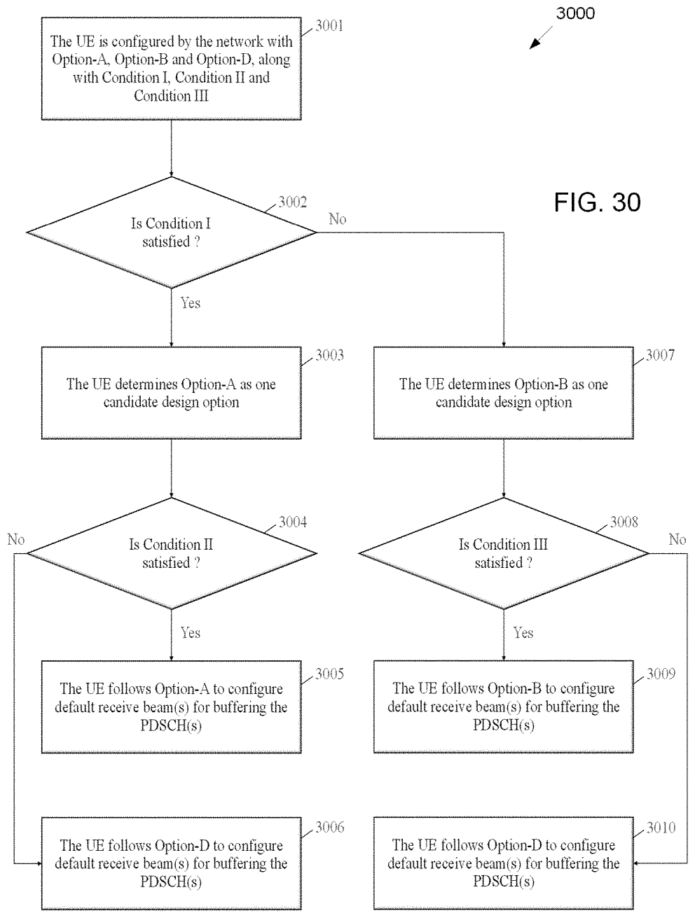

In some cases, the UE may not be configured by the network any priority rule/ordering (e.g., FIG. 29), but instead a set of explicit conditions along with the configured design options. For instance, the UE could be first configured by the network three options, Option-A, Option-B and Option-D. Further, the UE could be configured by the network three conditions, denoted by Condition I, Condition II and Condition III. If Condition I is satisfied, the UE would follow Option-A over Option-B. If Condition II is satisfied, the UE would follow Option-A over Option-D. If Condition III is satisfied, Option-B has a higher priority than Option-D. One example charactering how the UE would determine the appropriate design option (from Option-A, Option-B and Option-D) according to the configured conditions (Condition I, Condition II and Condition III) is shown in FIG. 30.

FIG. 30 illustrates a flowchart of a method 3000 for configuring and determining a default beam according to embodiments of the present disclosure. For example, the method 3000 as may be performed by a UE (e.g., 111-116 as illustrated in FIG. 1). An embodiment of the method 3000 shown in FIG. 30 is for illustration only. One or more of the components illustrated in FIG. 30 can be implemented in specialized circuitry configured to perform the noted functions or one or more of the components can be implemented by one or more processors executing instructions to perform the noted functions.

As indicated in FIG. 30, the UE could follow Option-A instead of Option-B and Option-D to configure the default receive beam(s) for receiving the PDSCHs, which is not possible if the UE is configured and follows the priority rule/ordering in FIG. 29. For example, Condition II in FIG. 30 could be: the previous N_tci (>1) TCI states/beams (not common TCI states/beams) indicated in the single DCI for all the coordinating TRPs are different from the explicitly configured default (common) TCI states and/or configured at a later time.

As illustrated in FIG. 30, in step 3001, a UE is configured by the network with Option-A, Option-B, and Option-D, along with Condition I, Condition II, and Condition III. In step 3002, the UE determines whether Condition I is satisfied. In step 3003, the UE determines Option-A as one candidate design option. In step 3004, the UE determines whether Condition II is satisfied. In step 3005, the UE follows Option-A to configure default receive beam(s) for buffering the PDSCH(s). In step 3006, the UE follows Option-D to configure default receive beam(s) for buffering the PDSCH(s). In step 3007, the UE determines Option-B as one candidate design option. In step 3008, the UE determines whether Condition III is satisfied. In step 3009, the UE follows Option-B to configure default receive beam(s) for buffering the PDSCH(s). In step 3010, the UE follows Option-D to configure default receive beam(s) for buffering the PDSCH(s).

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE), comprising:
a transceiver configured to receive:
a first physical downlink control channel (PDCCH) including a first downlink control information (DCI) format indicating one or more first unified transmission configuration indication (TCI) states;
a second PDCCH including a second DCI format indicating one or more second unified TCI states; and
information on a beam application time; and
a processor operably coupled to the transceiver, the processor configured to determine a quasi-co-location (QCL) assumption for reception of a physical layer shared channel (PDSCH) based on one of the one or more first and second unified TCI states and the beam application time,
wherein the transceiver is configured to receive the PDSCH according to the QCL assumption, and
wherein receptions of the first and second PDCCHs are in control resource sets (CORESETs) configured with same or different values of a coresetPoollndex.

2. The UE of claim 1, wherein the information on the beam application time includes at least one of:
information of a starting symbol to determine the beam application time;
a time duration of the beam application time; and
a subcarrier spacing to determine the beam application time.

3. The UE of claim 1, wherein the processor is further configured to determine:
a first beam application time for the one or more first unified TCI states indicated in the first PDCCH according to the information on the beam application time;
a second beam application time for the one or more second unified TCI states indicated in the second PDCCH according to the information on the beam application time;
a first time offset for reception of the PDSCH according to the first beam application time; and
a second time offset for reception of the PDSCH according to the second beam application time.

4. The UE of claim 3, wherein, when the first time offset is greater than or equal to the first beam application time, the processor is further configured to determine the QCL assumption for reception of the PDSCH according to reference signals in the one or more first unified TCI states indicated in the first PDCCH.

5. The UE of claim 3, wherein:
when the first time offset is smaller than the first beam application time, the processor is further configured to determine the QCL assumption for reception of the PDSCH according to at least one of:
reference signals in the one or more second unified TCI states indicated in the second PDCCH if the second time offset is greater than or equal to the second beam application time;
a QCL assumption for receiving the first PDCCH; and
a QCL assumption for receiving the second PDCCH.

6. The UE of claim 1, wherein, if the first DCI format indicates more than one first unified TCI state, the processor is further configured to determine the QCL assumption for reception of the PDSCH according to reference signals in at least one first unified TCI state indicated in the first PDCCH that is associated with the PDSCH.

7. The UE of claim 1, wherein, if the second DCI format indicates more than one second unified TCI state, the processor is further configured to determine the QCL assumption for reception of the PDSCH according to reference signals in at least one second unified TCI state indicated in the second PDCCH that is associated with the PDSCH.

8. A base station (BS), comprising:
a transceiver configured to transmit:
a first physical downlink control channel (PDCCH) including a first downlink control information (DCI) format indicating one or more first unified transmission configuration indication (TCI) states;
information on a beam application time; and
a physical layer shared channel (PDSCH) for reception according to a quasi-co-location (QCL) assumption that is based on (i) the beam application time and (ii) one of the one or more first unified TCI states or one or more second unified TCI states indicated in a second DCI format included in a second PDCCH,
wherein the first and second PDCCHs are in control resource sets (CORESETs) configured with same or different values of a coresetPoollndex.

9. The BS of claim 8, wherein the information on the beam application time includes at least one of:
information of a starting symbol to indicate the beam application time;
a time duration of the beam application time; and
a subcarrier spacing to indicate the beam application time.

10. The BS of claim 8, wherein:
a first beam application time for the one or more first unified TCI states indicated in the first PDCCH is based on the information on the beam application time;
a second beam application time for the one or more second unified TCI states indicated in the second PDCCH is based on the information on the beam application time;
a first time offset for reception of the PDSCH is based on the first beam application time; and
a second time offset for reception of the PDSCH is based on the second beam application time.

11. The BS of claim 10, wherein:
the first time offset is greater than or equal to the first beam application time, and
the QCL assumption for reception of the PDSCH is based on reference signals in the one or more first unified TCI states indicated in the first PDCCH.

12. The UE of claim 10, wherein:
the first time offset is smaller than the first beam application time, and
the QCL assumption for reception of the PDSCH is based on at least one of:
reference signals in the one or more second unified TCI states indicated in the second PDCCH if the second time offset is greater than or equal to the second beam application time;
a QCL assumption for receiving the first PDCCH; and
a QCL assumption for receiving the second PDCCH.

13. The BS of claim 8, wherein:
the first DCI format indicates more than one first unified TCI state,
the QCL assumption for reception of the PDSCH is based on reference signals in at least one first unified TCI state indicated in the first PDCCH that is associated with the PDSCH.

14. The BS of claim 8, wherein:
the transceiver is further configured to transmit the second PDCCH including the second DCI format indicating the one or more second unified TCI states,
the second DCI format indicates more than one second unified TCI state, and
the QCL assumption for reception of the PDSCH is based on reference signals in at least one second unified TCI state indicated in the second PDCCH that is associated with the PDSCH.

15. A method for operating a user equipment (UE), the method comprising:
receiving a first physical downlink control channel (PDCCH) including a first downlink control information (DCI) format indicating one or more first unified transmission configuration indication (TCI) states;
receiving a second PDCCH including a second DCI format indicating one or more second unified TCI states;
receiving information on a beam application time;
determining a quasi-co-location (QCL) assumption for reception of a physical layer shared channel (PDSCH) based on one of the one or more first and second unified TCI states and the beam application time; and
receiving the PDSCH according to the QCL assumption,
wherein receptions of the first and second PDCCHs are in control resource sets (CORESETs) configured with same or different values of a coresetPoollndex.

16. The method of claim 15, wherein the information on the beam application time includes at least one of:
information of a starting symbol to determine the beam application time;
a time duration of the beam application time; and
a subcarrier spacing to determine the beam application time.

17. The method of claim 15, further comprising:
determining a first beam application time for the one or more first unified TCI states indicated in the first PDCCH according to the information on the beam application time;
determining a first time offset for reception of the PDSCH according to the first beam application time; and
wherein determining the QCL assumption comprises, based on the first time offset being greater than or equal to the first beam application time, determining the QCL assumption for reception of the PDSCH according to reference signals in the one or more first unified TCI states indicated in the first PDCCH.

18. The method of claim 15, further comprising:
determining a first beam application time for the one or more first unified TCI states indicated in the first PDCCH according to the information on the beam application time;
determining a second beam application time for the one or more second unified TCI states indicated in the second PDCCH according to the information on the beam application time;
determining a first time offset for reception of the PDSCH according to the first beam application time; and
determining a second time offset for reception of the PDSCH according to the second beam application time,
wherein determining the QCL assumption comprises, based on the first time offset being smaller than the first beam application time, determining the QCL assumption for reception of the PDSCH according to at least one of:
reference signals in the one or more second unified TCI states indicated in the second PDCCH if the second time offset is greater than or equal to the second beam application time;
a QCL assumption for receiving the first PDCCH; and
a QCL assumption for receiving the second PDCCH.

19. The method of claim 15, wherein determining the QCL assumption comprises, based on the first DCI format indicating more than one first unified TCI state, determining the QCL assumption for reception of the PDSCH according to reference signals in at least one first unified TCI state indicated in the first PDCCH that is associated with the PDSCH.

20. The method of claim 15, wherein determining the QCL assumption comprises, based on the second DCI format indicating more than one second unified TCI state, determining the QCL assumption for reception of the PDSCH according to reference signals in at least one second unified TCI state indicated in the second PDCCH that is associated with the PDSCH.
